(19) United States
(12) Patent Application Publication
(10) Pub. No.: US 2026/0059428 A1
(43) Pub. Date: Feb. 26, 2026

(54) FIRST NODE, SECOND NODE, FOURTH NODE, FIFTH NODE, SIXTH NODE AND METHODS PERFORMED THEREBY FOR HANDLING INFORMATION PERTAINING TO A GROUP OF DEVICES

(71) Applicant: Telefonaktiebolaget LM Ericsson (publ), Stockholm (SE)

(72) Inventors: Emiliano MERINO VAZQUEZ, Madrid (ES); Maria Cruz BARTOLOME RODRIGO, Madrid (ES)

(21) Appl. No.: 19/104,740

(22) PCT Filed: Oct. 17, 2022
(86) PCT No.: PCT/EP2022/078783

§ 371 Date: Feb. 19, 2025

(30) Foreign Application Priority Data
Sep. 1, 2022 (EP) 22382816.1

(51) Int. Cl. H04W 48/04

(52) U.S. Cl. CPC H04W 48/04

(57) ABSTRACT

A computer-implemented method, performed by a first node. The method is for handling information pertaining to a group of devices. The first node operates in a communications system. The first node receives a first request from a second node to receive first information pertaining to an event for the group of devices. The request includes a first indication indicating that the group of devices is restricted to operate in one or more areas indicated by the second node. The first node also obtains, responsive to the received first request, second information regarding which one or more third nodes serve at least one of the indicated areas. The first node then sends, responsive to the obtained second information, a respective additional request to the one or more third nodes, requesting to receive the first information.

### TECHNICAL FIELD

The present disclosure relates generally to a first node and methods performed thereby for handling information pertaining to a group of devices. The present disclosure also relates generally to a second node, and methods performed thereby for handling the information pertaining to the group of devices. The present disclosure further relates generally to a fourth node, and methods performed thereby for handling the information pertaining to the group of devices. The present disclosure additionally relates generally to a fifth node, and methods performed thereby for handling the information pertaining to the group of devices. The present disclosure also relates generally to a sixth node, and methods performed thereby for handling the information pertaining to the group of devices.

### BACKGROUND

Computer systems in a communications network or communications system may comprise one or more nodes. A node may comprise one or more processors which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

FIG. 1 is a schematic diagram depicting a particular example of a 5G reference architecture as defined by 3GPP, which may be used as a reference for the present disclosure. An Application Function (AF) 1 may interact with the 3GPP Core Network through a Network Exposure Function (NEF) 2. In case the AF may be trusted, e.g., internal to the network operator, the AF may interact with the 3GPP Core Network directly, with no NEF involved. The NEF 2 may support different functionality, e.g., different Exposure Application Program Interfaces (APIs), e.g., sponsored Data, Quality of Service (QOS), etc., which may allow a content provider to request policies from the Mobile Network Operator (MNO). A Unified Data Repository (UDR), which is not depicted, may store data grouped into distinct collections of subscription-related information: subscription data, policy data, structured data for exposure, and application data. A Unified Data Management Function (UDM) 3 may generate 3GPP 5G AKA Authentication Vectors, handle user identification handling, support a UE's Serving NF Registration Management, e.g., storing the serving Access and Mobility Function (AMF) for a UE, storing the serving Session Management Function (SMF) for a UE's Packet Data Unit (PDU) Session, etc., support retrieval of the UE's individual subscription data for slice selection, and handle subscription data for network exposure capabilities applicable to an individual UE or a group of UEs. A Policy Control Function (PCF) 4 may support a unified policy framework to govern the network behavior. Specifically, the PCF 4 may provide Policy and Charging Control (PCC) rules to the Policy and Charging Enforcement Function (PCEF), that is, an SMF 5/User Plane function (UPF) 6 that may enforce policy and charging decisions according to provisioned Policy and Charging Control (PCC) rules. The SMF 5 may support different functionalities, e.g., session establishment, modify and release, and policy related functionalities such as termination of interfaces towards policy control functions, charging data collection, support of charging interfaces and control and coordination of charging data collection at the UPF 6. Specifically, the SMF 5 may receive the PCC rules from the PCF 4 and may configure the UPF 6 accordingly through an N4 7 reference point, Packet Flow Control Protocol (PFCP) protocol. The UPF 6 may support handling of user plane traffic based on the rules received from the SMF 5, e.g., packet inspection through Packet Detection Rules (PDRs) and different enforcement actions such as, e.g., traffic steering, QoS, Charging/Reporting through Forwarding Action Rules (FARs), QoS Enforcement Rules (QERs), and/or Usage Reporting Rule (URRs). The PCF 4 may provide policy rules to a UE 8 through the AMF 9. The AMF 9 may manage access of the UE 8, for example, when the UE 8 may be connected through different access networks, and mobility aspects of the UE 8. Also depicted in FIG. 1 is a Network Slice Selection Function (NSSF) 10, Network Repository Function (NRF) 11, an Authentication Server Function (AUSF) 12, a Radio Access Network (RAN) 13, and a Data Network (DN) 14. Each of the NSSF 10, the NEF 2, the NRF 11, the PCF 4, the UDM 3, the AF 1, the AUSF 12, the AMF 9, the SMF 5, the UE 8, the RAN 13, the UPF 6 and the DN 14 may have an interface through which they may be accessed, which as depicted in the Figure, may be, respectively: Nnssf 15, Nnef 16, Nnrf 17, Npcf 18, Nudm 19, Naf 20, Nausf 21, Namf 22, Nsmf 23, N1 24, and N2 25. The RAN 13 may have an interface N3 26 with the UPF 6, and the UPF 6 may have an interface N6 27 with the DN 14.

When an AF requests a configuration, such as monitoring of an event, for a Group of devices, e.g., UEs, the UDM receiving such request has to contact the serving node(s), e.g., the AMF(s) detecting the event for the device group members.

According to existing 5GC 3GPP standards, two approaches may be possible to perform this, as depicted in FIG. 2 and FIG. 3.

FIG. 2 is a signalling diagram depicting a first approach, over panels a) and b), according to existing 5GC 3GPP standards, to handle a request by an AF 28 for monitoring an event of a group of devices, which in the example comprises from N devices, from UE-1 29 to UE-N 30. Starting on panel a) of FIG. 2, in Step 1, the request from the AF 28 for the group of UEs 29, 30 reaches a NEF 31 as an Nnef_EventExposure_Subscribe message. The message identifies the event which the AF 28 wishes to monitor. The group of UEs 29, 30 is identified in the message by the AF 28 by an External Group Id. In Step 2. The NEF 31 forwards the request to a UDM 32 by sending a Nudm_EventExposure_Subscribe message with the External Group Id and the event identifier. The UDM 32 then needs to send this EventExposure request to the AMFs, e.g., AMF-1 33, that may serve the Group of UEs 29, 30. First, in Steps 3-4, the UDM needs to identify the internal UE Ids that correspond to the External UE Id by interrogating the UDR 34. Accordingly, in Step 3, the UDM 32 sends a Nudr_DataRepository_Query reQuest message to the UDR 34, including the External Group Id, and requesting a list of the UEs. In Step 4, the UDR 34 replies with a Nudr_DataRepository_Query response including the Internal Group ID of the requested UEs as well as the requested list of UEs. Second, in Steps 5-11, the UDM 32 needs to get the AMF identity for each affected UE. In order to accomplish this, the UDM 32 interrogates the UDR 34 using the UE context. For Each UE in the list, the UDM 32 fetches the UE context, which contains the AMF id, from the UDR 34 to build the list of serving AMFs for the group 29, 30. Accordingly, in Step 6, the UDM 32 sends a first Nudr_DataRepository_Query reQuest for the access context of UE-1 29 to the UDR 34. In Step 7, the UDM 32 then receives a first Nudr_DataRepository_Query response indicating that UE-1 is served by AMF-1 33. In Step 8, the UDM 32 sends a second Nudr_DataRepository_Query reQuest for the access context of UE-2 to the UDR 34. In Step 9, the UDM 32 then receives a second Nudr_DataRepository_Query response indicating that UE-2 is served by AMF-1 33. Continuing in panel b) of FIG. 2, in Step 10, the UDM 32 sends an Nth Nudr_DataRepository_Query reQuest for the access context of UE-N 30. In Step 11, the UDM 32 then receives an Nth Nudr_DataRepository_Query response indicating that UE-N 30 is also served by AMF-1 33. In Step 12, when the UDM 32 has finished running through the whole list of UEs 29, 30, it sends the event subscription to the list of AMFs for the group. In Step 13, the UDM 32 sends the EventExposure request to all the different AMFs identified in the UDR 34 responses. As depicted in Step 13, the UDM 32 particularly sends a Namf_EventExposure_Subscribe message including the External Group Id and the event identifier. AMF-1 33 is the only AMF serving all UEs 29, 30 in the group. Hence, the UDM 32 has gone through all UE contexts in the group to determine that the same AMF is serving all UEs 29, 30.

FIG. 3 is a signalling diagram depicting a second approach according to existing 5GC 3GPP standards, to handle a request by the AF 28 for monitoring the event of the group of N devices, which in this example also comprises from N devices, from UE-1 29 to UE-N 30. Steps 1 and Step 2 are similar to FIG. 1. The UDM 32 needs to send this EventExposure request to the AMFs that may serve the Group of UEs 29-31. In this case, the approach is to send, e.g., broadcast, the request to all the AMFs in the Public Land Mobile Network (PLMN). In Step 3, the UDM 32 discovers all the AMFs in the PLMN via the NEF 31 and sends the group subscription to all the AMFs since they may potentially serve any UE group member. Accordingly, in Steps 4-6, the UDM 32 sends the EventExposure request to all the AMFs in the PLMN, since they can potentially serve any of the UE in the Group. In the example depicted in FIG. 3, the PLMN comprises N AMFs, from AMF-1 33, including AMF-2 34, to AMF-N 35. The EventExposure request is sent as a respective Namf_EventExposure_Subscribe message in Each of Steps 4-6, each including the External Group Id and the event Identifier.

Since the event may be active for a long time, e.g., if the expiry time provided in the subscription is very large, existing methods for handling exposure to events in roaming scenarios may involve high overhead and usage of resources, as a result, impair the effective functioning of the communications network involved.

### SUMMARY

As part of the development of embodiments herein, one or more challenges with the existing technology will first be identified and discussed.

A communications network may comprise devices that may only be allowed to move in a restricted, limited, or narrowed area. For example, this may be the case of a group of drones whose flight permissions may only allow a specific area of service/operation, e.g., a geographical area.

Today the concept of “narrowed mobility” does not exist, therefore a specific mechanism or procedure for a UDM handling subscriptions or configurations targeting a group of UEs with this narrowed mobility does not exist.

The existence of devices of narrowed mobility in a communications network raises problems with the existing approaches in the 5GC 3GPP standards described in FIG. 2 and FIG. 3.

Particularly, in the case of the approach of FIG. 2, if the group of UEs 29, 30 have narrowed mobility, the UDM 32 needs to iterate all the N group members, which may be thousands of UEs, interacting with the UDR 34, to eventually build a list of AMFs with a single AMF, in the example, AMF-1 33. This causes a massive and useless signaling between the UDM 32 and the UDR 34.

In the case of the approach of FIG. 3, in which the approach is to send the request to all the AMFs in the PLMN, the approach has also drawbacks since the UDM 32 subscribes to all the AMFs. As noted in Step 7 of FIG. 3, if the UEs in the group do not leave the service area of AMF-1 33, then AMF-2 34. AMF-N 35 may store and monitor an event that will never be detected for any UE in the group. That is, AMF-2 34. AMF-N 35 may never be able to apply the configuration, e.g., detect the subscribed event, for any group member. Given that the expiry time/validity time requested by the network configurations of the AF 28 may last weeks or months, this implies that the network has reserved AMF resources uselessly, and also that the AMFs 34-35 will run through these configurations to eventually determine that they do not apply to the served UE. In short, this is a waste of storage and computing resources in the 5GC network.

According to the foregoing, it is an object of embodiments herein to improve the handling information pertaining to a group of devices in a communications system.

According to a first aspect of embodiments herein, the object is achieved by a computer-implemented method, performed by a first node. The method is for handling information pertaining to a group of devices. The first node operates in a communications system. The first node receives a first request from a second node operating in the communications system. The first request is to receive first information pertaining to an event for the group of devices. The request comprises a first indication. The first indication indicates that the group of devices is restricted to operate in one or more areas covered by the communications system. The one or more areas are indicated by the second node. The first node obtains, responsive to the received first request, second information. The second information is regarding which one or more third nodes serve at least one of the indicated one or more areas. The first node then sends, responsive to the obtained second information, a respective additional request to the one or more third nodes. The respective additional request requests to receive the first information for the group of devices.

According to a second aspect of embodiments herein, the object is achieved by a computer-implemented method, performed by the second node. The method is for handling the information pertaining to the group of devices. The second node operates in the communications system. The second node receives a first previous request from a sixth node operating with the communications system. The first previous request is to receive the first information pertaining to the event for the group of devices. The second node also sends, responsive to the received first previous request, the first request to the first node operating in the communications system. The first request is to receive the first information. The request comprises the first indication. The first indication indicates that the group of devices is restricted to operate in the one or more areas covered by the communications system. The one or more areas are obtained by the second node. By sending the first request, the second node initiates a provision of the first information to the sixth node.

According to a third aspect of embodiments herein, the object is achieved by a computer-implemented method, performed by a fourth node. The method is for handling the information pertaining to the group of devices. The fourth node operates in the communications system. The fourth node receives a second request from the first node operating in the communications system. The second request requests to receive second information regarding which one or more third nodes serve at least one of the one or more areas indicated in the second request. The fourth node determines, responsive to the received second request, the second information. The fourth node then sends, in response to the received second request, a first response to the first node. The first response comprises the requested second information.

According to a fourth aspect of embodiments herein, the object is achieved by a computer-implemented method, performed by the sixth node. The method is for handling the information pertaining to the group of devices. The sixth node operates with the communications system. The sixth node sends the first previous request to the second node operating with the communications system. The first previous request is to receive the first information pertaining to the event for the group of devices. The first previous request comprises the first indication. The first indication indicates that the group of devices is restricted to operate in the one or more areas covered by the communications system. The one or more areas are indicated by the sixth node. The sixth node also obtains the first information responsive to the sent first previous request.

According to a fifth aspect of embodiments herein, the object is achieved by a computer-implemented method, performed by a fifth node. The method is for handling the information pertaining to the group of devices. The fifth node operates in a communications system. The fifth node receives a second prior request from the first node operating in the communications system. The second prior request requests first prior information. The first prior information indicates whether or not the group of devices is restricted to operate in the limited group of areas. The fifth node then sends, in response to the received second prior request, a first prior response to the first node. The first prior response comprises the requested first prior information.

According to a sixth aspect of embodiments herein, the object is achieved by the first node, for handling the information pertaining to the group of devices. The first node is configured to operate in the communications system. The first node is further configured to receive the first request from the second node configured to operate in the communications system. The first request is configured to be to receive the first information configured to pertain to the event for the group of devices. The request is configured to comprise the first indication. The first indication is configured to indicate that the group of devices is restricted to operate in the one or more areas configured to be covered by the communications system.

The one or more areas are configured to be indicated by the second node. The first node is further configured to obtain, responsive to the received first request, the second information configured to be regarding which one or more third nodes are configured to serve at least one of the indicated one or more areas. The first node is further configured to send, responsive to the obtained second information, the respective additional request to the one or more third nodes. The respective additional request is configured to request to receive the first information for the group of devices.

According to a seventh aspect of embodiments herein, the object is achieved by the second node, for handling the information pertaining to the group of devices. The second node is configured to operate in the communications system. The second node is further configured to receive the first previous request from the sixth node configured to operate with the communications system. The first previous request is configured to be to receive the first information configured to pertain to the event for the group of devices. The second node is further configured to send, responsive to the received first previous request, the first request to the first node configured to operate in the communications system. The first request is configured to be to receive the first information. The request is configured to comprise the first indication. The first indication is configured to indicate that the group of devices is restricted to operate in the one or more areas configured to be covered by the communications system.

The one or more areas are configured to be obtained by the second node. By sending the first request, the second node is configured to initiate the provision of the first information to the sixth node.

According to an eighth aspect of embodiments herein, the object is achieved by the fourth node, for handling the information pertaining to the group of devices. The fourth node is configured to operate in the communications system. The fourth node is further configured to receive the second request from the first node configured to operate in the communications system. The second request is configured to request to receive the second information configured to be regarding which one or more third nodes are configured to serve at least one of the one or more areas configured to be indicated in the second request. The fourth node is further configured to determine, responsive to the received second request, the second information. The fourth node is further configured to send, in response to the received second request, the first response to the first node. The first response is configured to comprise the requested second information.

According to a ninth aspect of embodiments herein, the object is achieved by the sixth node, for handling the information pertaining to the group of devices. The sixth node is configured to operate with the communications system. The sixth node is further configured to send the first previous request to the second node configured to operate with the communications system. The first previous request is configured to be to receive the first information configured to pertain to the event for the group of devices. The first previous request is configured to comprise the first indication. The first indication is configured to indicate that the group of devices is restricted to operate in the one or more areas configured to be covered by the communications system. The one or more areas are configured to be indicated by the sixth node. The sixth node is further configured to obtain the first information responsive to the sent first previous request.

According to a tenth aspect of embodiments herein, the object is achieved by the fifth node, for handling the information pertaining to the group of devices. The fifth node is configured to operate in the communications system. The fifth node is further configured to receive the second prior request from the first node configured to operate in the communications system. The second prior request is configured to request the first prior information. The first prior information is configured to indicate whether or not the group of devices are restricted to operate in the limited group of areas. The fifth node is further configured to send, in response to the received second prior request, the first prior response to the first node. The first prior response is configured to comprise the requested first prior information.

According to embodiments herein, a new concept of narrowed mobility for a device, or group of devices may be defined, which may allow optimization of network procedures to reach only serving nodes, e.g., AMFs, in the corresponding areas, e.g., Tracking Area identities (TAIs), for the indicated narrowed mobility.

By receiving the first request with the first indication from the second node, the first node may be enabled to know that the first request to receive the first information may apply to the devices with restricted/reduced/limited mobility, e.g., restricted to one or multiple TAIs. This may enable the first node to know that it may refrain from contacting all the nodes, e.g., AMFs, that may be comprised in the communications system. That is, the first node may be enabled to refrain from contacting all the nodes, e.g., AMFs, that may have been able to serve the group of devices, had they not had narrowed mobility. The first node may be enabled to know that it may need to discover the affected nodes, that is, the one or more third nodes, to be able to send the request to receive first information to them, and to them only. This may enable the first node to avoid having to perform a procedure to identify the list of nodes, e.g., AMFs, that may serve the list of devices in the group of devices that may, e.g., correspond to the external Group Id. Receiving the first request with the first indication may further enable the first node to avoid contacting serving nodes, e.g., AMFs, which may not serve the area of operation, hence avoiding the reservation of resources which may never be used in many serving nodes/AMFs. Accordingly, massive and useless signaling may be avoided, and storage and computing resources in the 5GC network may be saved, enabling an improved operation of the communications system.

By obtaining the second information, the first node may then be enabled to send a respective additional request to receive the first information only to the one or more third nodes that may serve the one or more areas for which the group of devices may have narrowed mobility, since e.g., the group of devices may never be allowed to leave the area to enter a TAI not present in the TAI list associated to the area. This may then enable the first node to achieve the benefits outlined in the previous paragraph.

By sending the respective additional requests to receive the first information for the group of devices, the first node may enable to subscribe to receive the first information from the one or more third nodes and from them only. This may then enable the first node to achieve the benefits outlined earlier, in the previous paragraphs.

By receiving the second request requesting to receive the second information, the fourth node may be able to determine the second information and then send it to the first node, enabling the first node to achieve the benefits outlined in the previous paragraphs.

By the sixth node sending the first previous request comprising the first indication, the second node may then be enabled to provide the first indication to the first node, and thereby enable the first node to achieve the benefits outlined in the previous paragraphs.

By receiving the second prior request from the first node and sending the first prior response to the first node comprising the first prior information, the fifth node may enable the first node to know whether or not the group of devices may be restricted to operate in the limited group of areas. The first node may then be enabled to provide this information to the second node, so that the second node may be enabled to know that the first previous request received from the sixth node may apply for narrowed-mobility. The second node may in turn be enabled to then provide this information to the first node, enabling the first node to achieve the benefits outlined in the previous paragraphs. The method performed by the fifth node may be particularly useful for embodiments wherein the second node may not be able to derive itself whether the first previous request received from the sixth node may apply for narrowed-mobility from a local configuration, or by an indication from the sixth node.

### BRIEF DESCRIPTION OF THE DRAWINGS

Examples of embodiments herein are described in more detail with reference to the accompanying drawings, according to the following description.

FIG. 1 is a schematic diagram illustrating an example of a 5G Network Architecture, according to existing methods.

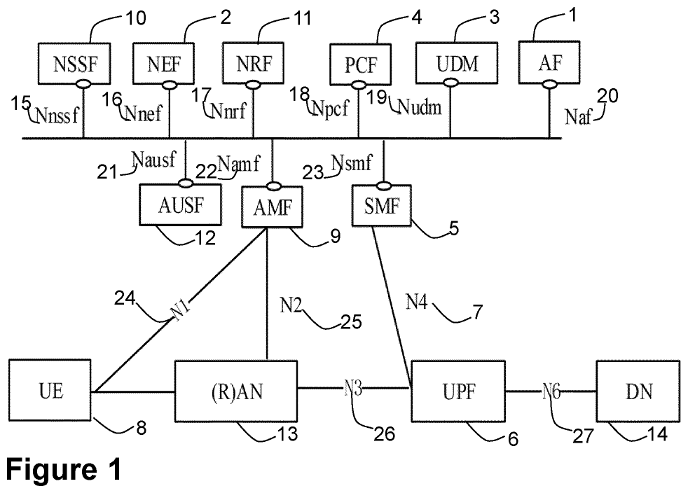

FIG. 2 is a signalling diagram illustrating an example of a first approach to handle a request for monitoring an event for a group of devices, according to existing methods.

FIG. 3 is a signalling diagram illustrating an example of a second approach to handle a request for monitoring an event for a group of devices, according to existing methods.

FIG. 4 is a schematic diagram illustrating a non-limiting example of a communications system, according to embodiments herein.

FIG. 5 is a flowchart depicting embodiments of a method in a first node, according to embodiments herein.

FIG. 6 is a flowchart depicting embodiments of a method in a second node, according to embodiments herein.

FIG. 7 is a flowchart depicting embodiments of a method in a fourth node, according to embodiments herein.

FIG. 8 is a flowchart depicting embodiments of a method in a sixth node, according to embodiments herein.

FIG. 9 is a flowchart depicting embodiments of a method in a fifth node, according to embodiments herein.

FIG. 10 is a schematic diagram depicting a non-limiting example of signalling between nodes in a communications system, according to embodiments herein.

FIG. 11 is a schematic diagram depicting another non-limiting example of signalling between nodes in a communications system, according to embodiments herein.

FIG. 12 is a schematic diagram depicting yet another non-limiting example of signalling between nodes in a communications system, according to embodiments herein.

FIG. 13 is a schematic block diagram illustrating two non-limiting examples, a) and b), of a first node, according to embodiments herein.

FIG. 14 is a schematic block diagram illustrating two non-limiting examples, a) and b), of a second node, according to embodiments herein.

FIG. 15 is a schematic block diagram illustrating two non-limiting examples, a) and b), of a fourth node, according to embodiments herein.

FIG. 16 is a schematic block diagram illustrating two non-limiting examples, a) and b), of a sixth node, according to embodiments herein.

FIG. 17 is a schematic block diagram illustrating two non-limiting examples, a) and b), of a fifth node, according to embodiments herein.

### DETAILED DESCRIPTION

Certain aspects of the present disclosure and their embodiments address one or more of the challenges identified with the existing methods and provide solutions to the challenges discussed.

Embodiments herein may relate to methods of handling of subscriptions or configurations targeting a group of devices with narrowed mobility. According to embodiments herein, a new concept of narrowed mobility for a device, or group of devices may be defined, which may allow optimization of network procedures to reach only serving nodes, e.g., AMFs, in the corresponding areas, e.g., Tracking Area identities (TAIs), for the indicated narrowed mobility. Particular embodiments herein may relate to the 5G Core, and in particular to methods by a UDM of handling of subscriptions or configurations targeting a group of devices with narrowed mobility.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

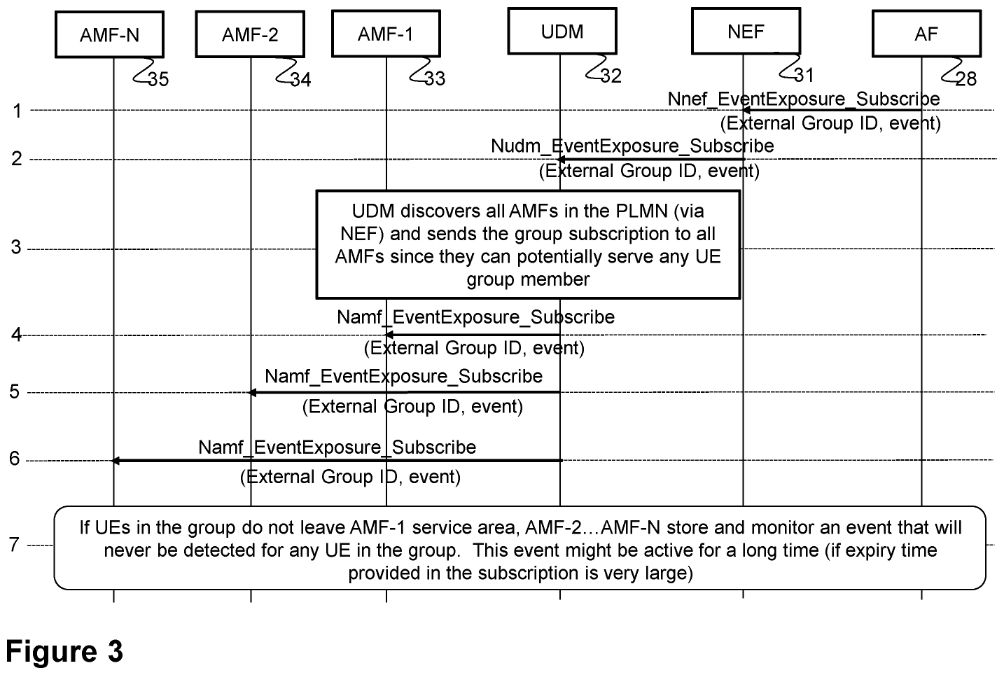

FIG. 4 depicts two non-limiting examples, in panels “a” and “b”, respectively, of a communications system 100, in which embodiments herein may be implemented. In some example implementations, such as that depicted in the non-limiting example of FIG. 4a, the communications system 100 may be a computer network. In other example implementations, such as that depicted in the non-limiting example of FIG. 4b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices, with serving beams. The communications system 100 may for example be a network such as a 5G system, or a newer system supporting similar functionality. The telecommunications system may further support other technologies, such as a Long-Term Evolution (LTE) network, e.g., LTE Frequency Division Duplex (FDD), LTE Time Division Duplex (TDD), LTE Half-Duplex Frequency Division Duplex (HD-FDD), or LTE operating in an unlicensed band, Wideband Code Division Multiple Access (WCDMA), Universal Mobile Telecommunications System Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, a second node 112, one or more third nodes 113, a fourth node 114, a fifth node 115 and a sixth node 116 are depicted in FIG. 4. The first node 111, the second node 112, the one or more third nodes 113, the fourth node 114, and the fifth node 115 are comprised in the communications system 100. The sixth node 116 operates with the communications system 100, e.g., it may be external to the communications system 100. It may be understood that the communications system 100 may comprise more nodes than those represented on FIG. 4.

Any of the first node 111, the second node 112, the one or more third nodes 113, the fourth node 114, the fifth node 115 and the sixth node 116 may be understood, respectively, as a first computer system, a second computer system, a third computer system, a fourth computer system, a fifth computer system and a sixth computer system. In some examples, any of the first node 111, the second node 112, the one or more third nodes 113, the fourth node 114, the fifth node 115 and the sixth node 116 may be implemented as a standalone server in e.g., a host computer in the cloud 120, as depicted in the non-limiting example depicted in panel b) of FIG. 4. Any of the first node 111, the second node 112, the one or more third nodes 113, the fourth node 114, the fifth node 115 and the sixth node 116 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the one or more third nodes 113, the fourth node 114, the fifth node 115 and the sixth node 116 may also be implemented as processing resources in a server farm.

Any of the first node 111, the second node 112, the one or more third nodes 113, the fourth node 114, the fifth node 115 and the sixth node 116 may be independent and separate nodes. In some examples, any of the first node 111, the second node 112, the one or more third nodes 113, the fourth node 114, the fifth node 115 and the sixth node 116 may be co-localized.

In some examples of embodiments herein, the first node 111 may be understood as a node that may have a capability to handle user identification, support a UE's Serving NF Registration Management, e.g., storing the serving AMF for a UE, storing the serving SMF for a UE's Packet Data Unit (PDU) Session, etc., support retrieval of the UE's individual subscription data for access and mobility and session management, and handle subscription for network exposure capabilities applicable to an individual UE or a group of UE. As depicted in the non-limiting example of FIG. 4, a non-limiting example of the first node 111, wherein the communications system 100 may be a 5G network, may be UDM.

The second node 112 may be a node that may have a capability to manage exposure to different events, e.g., different Exposure Application Program Interfaces (APIs). The second node 112 may optionally support other functionalities, such as handling e.g., sponsored Data, Quality of Service (QOS), etc., which may allow a content provider to request policies from the Mobile Network Operator (MNO). In some embodiments, as in the non-limiting example of FIG. 4, the second node 112 may be a NEF.

Any of the one or more third nodes 113 may be a node having a capability to manage access of a device such as the device 130 described below to the communications system 100, and mobility aspects of the device 130. In some particular examples, any of the one or more third nodes 113 may be an AMF, e.g., in a 5G network.

The fourth node 114 may be a node having a capability to store and maintain addresses for notifications registered by some nodes. In some particular examples wherein the communications system 100 may be a 5G network, the fourth node 114 may be an NRF operating in the communications system 100. This is depicted in the non-limiting example of FIG. 4 for illustrative purposes only.

The fifth node 115 may be a node having a capability to store data, e.g., grouped into distinct collections of subscription-related information, such as subscription data, policy data, structured data for exposure, and application data. In some particular examples, such as in those wherein the first node 111 may be a UDM, the fifth node 115 may be a UDR, e.g., in a 5G network, as depicted in the non-limiting example of FIG. 4.

The sixth node 116 may be a node having a capability to manage service of an application to a device. In some particular examples, the sixth node 116 may be an AF, e.g., in a 5G network.

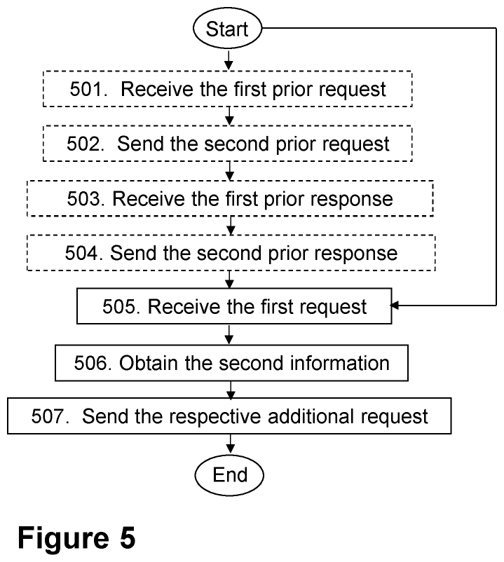

The communications system 100 may also comprise a group of devices 130 represented in FIG. 4 with three devices for illustration purposes only. It may be understood that the group of devices 130 may comprise fewer or additional devices. Any of the devices in the group of devices 130 may be also known as e.g., user equipment (UE), a wireless device, mobile terminal, wireless terminal and/or mobile station, mobile telephone, cellular telephone, or laptop with wireless capability, an Internet of Things (IoT) device, a sensor, or a Customer Premises Equipment (CPE), just to mention some further examples. Any of the devices in the group of devices 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the devices in the group of devices 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100. In the non-limiting example of FIG. 6, the group of devices 130 may be a group of UEs, which may be understood to be for illustrative purposes only.

The communications system 100 may comprise one or more radio network nodes, whereof a radio network node 140 is depicted in FIG. 4b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The first node 111 may communicate with the fourth node 114 over a second link 152, e.g., a radio link or a wired link. The first node 111 may communicate with each of the one or more third nodes 113 over a respective third link 153, e.g., a radio link or a wired link. The fourth node 114 may communicate with each of the one or more third nodes 113 over a respective fourth link 154, e.g., a radio link or a wired link. The second node 112 may communicate, directly or indirectly, with the sixth node 116 over a fifth link 155, e.g., a radio link or a wired link. The first node 111 may communicate with the fifth node 115 over a sixth link 156, e.g., a radio link or a wired link. The radio network node 140 may communicate, directly or indirectly via the cloud 120, e.g., with one or more nodes comprised in the communications system 100, via a seventh link 157, e.g., a radio link or a wired link. The radio network node 140 may communicate with any of the devices in the group of devices 130 over a respective eighth link 158, e.g., a radio link. Any of the devices in the group of devices 130 may communicate with any of the nodes in the communications system 100 over a respective ninth link, e.g., radio link or a wired link. This is not depicted in panel a) to simplify the figure.

Any of the first link 151, the second link 152, the respective third link 153, the respective fourth link 154, the fifth link 155, the sixth link 156, the seventh link 157, the respective eighth link 158 and/or the ninth link may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 4.

Although terminology from Long Term Evolution (LTE)/5G has been used in this disclosure to exemplify the embodiments herein, this should not be seen as limiting the scope of the embodiments herein to only the aforementioned system. Other wireless systems supporting similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

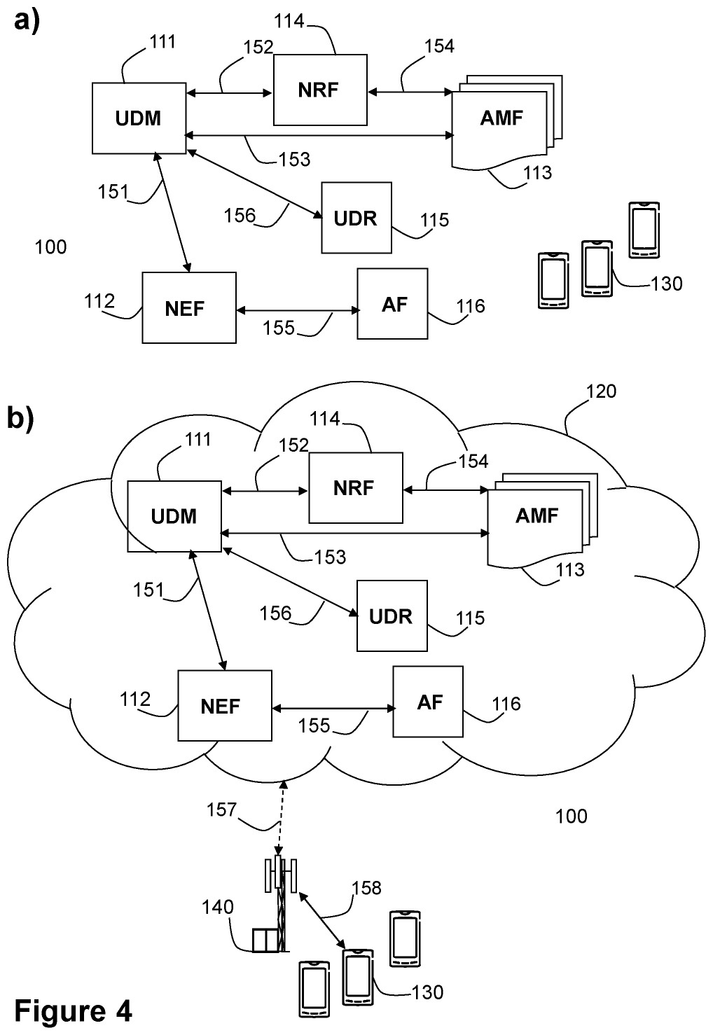

Embodiments of a computer-implemented method, performed by the first node 111, will now be described with reference to the flowchart depicted in FIG. 5. The method may be understood to be for handling information pertaining to the group of devices 130. The first node 111 operates in the communications system 100.

In some embodiments, the communications system 100 may be a Fifth Generation, 5G, system.

The first node 111 may be a UDM node.

Several embodiments are comprised herein. The method may comprise three or more of the following actions. In some embodiments, all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 5.

In FIG. 5, optional actions are represented with dashed lines.

### Action 501

Embodiments herein may be understood to relate to defining a new concept of narrowed mobility, which may apply to instances wherein the group of nodes 130 may have mobility limited to a particular geographical area, e.g., UEs or drones moving only among a list of TAIs. This new concept may be shared by second node 112 and the sixth node 116.

According to embodiments herein which will be described later in further detail, the sixth node 116 may subscribe to a given event in the communications system 100, e.g., UE location change, for the group of devices 130. For that purpose, the sixth node 116 may send a request to receive a notification of the event for the group of devices 130 to the second node 112. The second node 112 may be, e.g., a NEF node. The sixth node 116 may be, e.g., an AF node.

According to some embodiments herein, the second node 112 may then need to check if narrowed-mobility may apply for the group of devices 130, which may group be identified by an indicated External GroupId. For that, the second node 112 may, according to some of these embodiments, need to get information stored in the fifth node 115 which may be associated with the group of devices 130, e.g., with that External GroupId. The fifth node 115 may be a UDR.

The second node 112 may send such a request via the first node 111. This may be understood to require, according to embodiments herein, that data may have been stored for the group of devices 130, e.g., identified by their ExternalGroupId, that may include an indication, e.g., Boolean, of whether narrowed-mobility may apply for this group of devices 130, e.g., this GroupID. In addition, the information about which geographical area, e.g., GeoArea, the narrowed mobility may correspond to, may be included as well as new data.

In this Action 501, the first node 111 may receive a first prior request from the second node 112. The first prior request may be to request first prior information indicating whether or not the group of devices 130 may be restricted to operate in a limited group of areas. In other words, in this Action 501, the first node 111 may receive an inquiry to know if the group of devices 130 have a narrowed mobility.

Each of the one or more areas may be identified by a Tracking Area Information (TAI).

In some embodiments, the one or more areas may be identified by a list of TAIs.

The receiving of the first prior request may be performed e.g., via the first link 151.

In some embodiments, the first node 111 may be a UDM and the second node 112 may be a NEF. In some of such embodiments, the first prior request may be a Nudm_SubscriberDataManagement_Get request.

The first prior request may comprise a flag, referred to herein as a third flag, explicitly indicating that the first prior information requested is to indicate whether or not the group of devices 130 is restricted to operate in a limited group of areas.

The third flag may be a narrowed mobility data flag. The third flag may be in the Nudm_SubscriberDataManagement_Get request.

The first prior request may further indicate an identifier or identity (id) of the group of devices 130, e.g., the ExternalGroupId.

The receiving of the first prior request may be performed e.g., via the third link 153.

By receiving the first prior request from the second node 112 in this Action 501, the first node 111 may enable the second node to 112 to get information stored in the fifth node 115 via the first node 111, and check if narrowed-mobility may apply for the group of devices 130. This may be understood to then enable the second node 112 to indicate whether the group of devices 130 may have narrowed-mobility or not when subscribing to the event. Such an indication may then enable a receiving node to refrain from contacting any nodes which may not be able to serve the areas where the devices in the group of devices 130 may not be able to move. By the information about which geographical area, e.g., GeoArea, the narrowed mobility may correspond to being included, the first node 111 may then be enabled to know which geographical area this “narrowed-mobility” may be applicable to.

### Action 502

In this Action 502, the first node 111 may send, responsive to the received first prior request, a second prior request to the fifth node 115 operating in the communications system 100. The second prior request may request the first prior information.

The sending of the second prior request may be performed e.g., via the sixth link 156.

The second prior request may be a Nudr_DataRepository_Query request, e.g., in embodiments wherein the first node 111 may be the UDM node and the fifth node 115 may be the UDR.

The second prior request may also comprise the third flag, e.g., the narrowed mobility data flag. The second prior request may further indicate the ID of the group of devices 130, e.g., the ExternalGroupId.

In some embodiments, the second prior request may further comprise the information about which geographical area the narrowed mobility may correspond to, e.g., the second prior request may further comprise the GeoArea.

By sending the second prior request to the fifth node 115 in this Action 502, the first node 111 may be able to get information stored in the fifth node 115 for the second node 112, and check if narrowed-mobility may apply for the group of devices 130. This may be understood to then enable the second node 112 to indicate whether the group of devices 130 may have narrowed-mobility or not when subscribing to the event. Such an indication may then enable a receiving node to refrain from contacting any nodes which may not be able to serve the areas where the devices in the group of devices 130 may not be able to move.

### Action 503

In this Action 503, the first node 111 may receive, in response to the sent second prior request, from the fifth node 115, a first prior response. The first prior response may comprise the requested first prior information.

The first prior response may be a Nudr_DataRepository_Query response. This may be in embodiments wherein the first node 111 may be the UDM node and the fifth node 115 may be the UDR.

The first prior response may comprise a fourth flag indicating whether or not the group of devices 130 may be restricted to operate in the limited group of areas. The fourth flag may be a narrowed-mobility indication, e.g., in the Nudr_DataRepository_Query response. The fourth flag may be the same as the third flag.

The first prior response may further comprise the GeoArea.

By receiving the first prior response from the fifth node 115 in this Action 503, the first node 111 may be able to get the information stored in the fifth node 115 for the second node 112, and enable the second node 112 to find out if narrowed-mobility may apply for the group of devices 130. This may be understood to then enable the second node 112 to indicate whether the group of devices 130 may have narrowed-mobility or not when subscribing to the event. Such an indication may then enable a receiving node to refrain from contacting any nodes which may not be able to serve the areas where the devices in the group of devices 130 may not be able to move.

### Action 504

In this Action 504, the first node 111 may send, responsive to the received first prior response, a second prior response to the second node 112. The second prior response may comprise the first prior information.

In some of such embodiments, the second prior response may be a Nudm_SubscriberDataManagement_Get response. This may apply to embodiments wherein the first node 111 may be the UDM and the second node 112 may be the NEF.

The second prior response may comprise the fourth flag indicating whether or not the group of devices 130 may be restricted to operate in the limited group of areas. The fourth flag may be the narrowed-mobility indication, e.g., in the Nudm_SubscriberDataManagement_Get response.

The second prior response may further comprise the GeoArea.

The sending of the second prior response in this Action 504 may be performed e.g., via the first link 151.

By sending the second prior response to the second node 112 in this Action 504, the first node 111 may provide the information stored in the fifth node 115 to the second node 112, and enable the second node 112 to find out if narrowed-mobility may apply for the group of devices 130. This may be understood to then enable the second node 112 to indicate whether the group of devices 130 may have narrowed-mobility or not when subscribing to the event. Such an indication may then enable a receiving node to refrain from contacting any nodes which may not be able to serve the areas where the devices in the group of devices 130 may not be able to move.

### Action 505

In this Action 505, the first node 111 receives a first request from the second node 112 operating in the communications system 100. The first request is to receive first information, e.g., notifications, pertaining to the event for the group of devices 130. The request comprises a first indication. The first indication indicates that the group of devices 130 is restricted to operate in one or more areas covered by the communications system 100. The one or more areas are indicated by the second node 112.

The first request may be a Nudm_EventExposure_Subscribe message. This may apply to embodiments wherein the first node 111 may be the UDM and the second node 112 may be the NEF.

The first indication may be a first flag in a subscription request.

The first flag may be a narrowed-mobility flag in a Nnef_EventExposure_Subscribe request

The first request may further comprise the ID of the group of devices 130, e.g., the ExternalGroupId.

The first request may also indicate the one or more areas, e.g., indicated as a TAI list.

The event may be indicated with another flag indicating the event.

The received first request may be based on the sent second prior response in Action 504. That is, the first request may include the first flag, with the proviso the second prior response may have included the fourth flag.

The receiving of the first request in this Action 505 may be performed e.g., via the first link 151.

By receiving the first request with the first indication from the second node 112 in this Action 505, the first node 111 may be enabled to know that the first request to receive first information applies to the devices with restricted/reduced/limited mobility, e.g., restricted to one or multiple TAIs. This may enable the first node 111 to know that it may refrain from contacting all the nodes, e.g., AMFs, that may be comprised in the communications system 100. That is, the first node 111 may be enabled to refrain from contacting all the nodes, e.g., AMFs, that may have been able to serve the group of devices 130, had they not had narrowed mobility. The first node 111 may be enabled to know that it may need to discover the affected nodes, that is, the one or more third nodes 113, to be able to send the request to receive first information to them, and to them only. This may enable the first node 111 to avoid having to perform a procedure to identify the list of nodes, e.g., AMFs, that may serve the list of devices in the group of devices 130 that may, e.g., correspond to the external Group Id. Receiving the first request with the first indication in this Action 505, may further enable the first node 111 to avoid contacting serving nodes, e.g., AMFs, which do not serve the area of operation, hence avoiding the reservation of resources which may never be used in many serving nodes/AMFs. Accordingly, massive and useless signaling may be avoided, and storage and computing resources in the 5GC network may be saved, enabling an improved operation of the communications system 100.

### Action 506

In this Action 506, the first node 111 obtains, responsive to the received first request, second information. The second information is regarding which one or more third nodes 113 serve at least one of the indicated one or more areas.

Each of the one or more third nodes 113 may be an AMF node.

Obtaining may comprise any of retrieving, fetching, deriving or receiving.

In some embodiments, when the first node 111 may receive the first request with the first flag, this may trigger a discovery procedure from first node 111 to the fourth node 114 to discover which one or more third nodes 113 may be serving at least one of the TAIs in the area. This discovery procedure may include a new indication, in addition to the list of TAIs included, so that the fourth node 114 may find the one or more third nodes 113 which may be at least serving one of the TAIs in the list, instead of serving all the TAIs.

In some embodiments, the obtaining of the second information may comprise sending, responsive to the received first request, a second request to the fourth node 114 operating in the communications system 100. The second request may request to receive the second information. In such embodiments, the obtaining of the second information may also comprise receiving, responsive to the sent second request, a first response comprising the requested second information.

The second request may comprise a second flag explicitly indicating that the second information is to be regarding which one or more third nodes 113 serve at least one of the indicated one or more areas. The second flag may be an “at least one” flag or a flag with a different denomination but the same functionality.

When the fourth node 114 may receive the second flag, e.g., to run an OR operand for the TAI matching, instead of AND operand, then it may need to return all the one or more third nodes 113 matching “at least one”of the provided TAIs.

The fourth node 114 may be an NRF node.

In some of these embodiments, when the first node 111 may receive the first request with the first flag, this may trigger a newly modified NRF Discovery from UDM to NRF to discover AMFs serving at least one of the TAIs in the area. This NF discover may include the second flag, in addition to the list of TAIs included, so that the NRF may find AMFs which are at least serving one of the TAIs in the list, instead of serving all the TAIs as existing methods. The second request may be an Nnrf_NFDiscovery_NFDiscover request. The first response may be an Nnrf_NFDiscovery_NF Discover response This may be the case in embodiments wherein the first node 111 may be the UDM and the fourth node 114 may be the NRF.

The second flag may be an Nnrf_NFDiscover flag.

In particular examples, the second request may comprise the second flag, the indication of the one or more areas, e.g., the TAI list, and a further indication of a type of the target network function, e.g., “target-nf-type=AMF”.

The sending of the second request and the receiving of the first response in this Action 506 may be performed e.g., via the second link 152.

By obtaining the second information in this Action 506, the first node 111 may then be enabled to send a respective additional request to receive the first information only to the one or more third nodes 113 that may serve the one or more areas for which the group of devices 130 may have narrowed mobility, since the group of devices 130 may never be allowed to leave the area to enter a TAI not present in the TAI list associated to the area. This may then enable the first node 111 to achieve the benefits outlined earlier, in relation to Action 505.

### Action 507

In this Action 507, the first node 111 sends, responsive to the obtained second information, a respective additional request to the one or more third nodes 113. The respective additional request requests to receive the first information for the group of devices 130.

Each respective additional request may be Namf_EventExposure_Subscribe request.

This may apply in embodiments wherein the first node 111 may be the UDM and each of the one or more third nodes 113 may be an AMF node.

The sending of the respective additional request in this Action 507 may be performed e.g., via the respective third link 153.

The respective additional request may further indicate the ID of the group of devices 130, e.g., the ExternalGroupId. The respective additional request may also indicate the another flag of the event.

By sending the respective additional request requests to receive the first information for the group of devices 130, the first node 111 may enable to subscribe to receive the first information from the one or more third nodes 113 and from them only. This may then enable the first node 111 to achieve the benefits outlined earlier, in relation to Action 505.

Embodiments of a computer-implemented method performed by the second node 112, will now be described with reference to the flowchart depicted in FIG. 6. The method may be understood to be for handling the information pertaining to the group of devices 130. The second node 112 operates in the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 6, optional actions are depicted with dashed lines.

The detailed description of some of the following corresponds to the same references provided above, in relation to the actions described for the first node 111 and will thus not be repeated here to simplify the description. For example, in some embodiments, the second node 112 may be the NEF, and the first node 111 may be the UDM.

### Action 601

In this Action 601, the second node 112 receives a first previous request from the sixth node 116 operating with the communications system 100. The first previous request is to receive the first information pertaining to the event for the group of devices 130. That is, the second node 112 may receive a subscription request from the sixth node 116 to the receive notifications about the event in the communications system 100, e.g., UE location change, for the group of devices 130.

The receiving in this Action 601 may be performed e.g., via the fifth link 155.

The second node 112 may be the NEF node. The sixth node 116 may be the AF node.

The first previous request may be a Nnef_EventExposure_Subscribe request. This may apply to embodiments wherein the second node 112 may be the NEF and the sixth node 116 may be the AF.

The first previous request may indicate the event with the another flag.

The first previous request may further indicate the ID of the group of devices 130, e.g., the ExternalGroupId.

The second node 112 may, upon receiving the need to identify whether the group of devices 130 may have narrowed mobility. The second node 112 may be able to perform this identification in different ways. According to a first group of embodiments herein, the sixth node 116 may have optionally included the first flag, that is, the narrowed-mobility flag, in the first previous request. This may be understood to inform the second node 112 that the request is for devices with a narrowed mobility. This in turn may also enable the second node 112 to refrain from having to get this information from the fifth node 115 via the first node 111. Moreover, the second node 112 may be enabled to include the first flag in further signalling, e.g., the first request, to subscribe to the event.

Optionally, the first previous request may also indicate the information about which geographical area the narrowed mobility may correspond to, e.g., the first previous request may further comprise the GeoArea. This may then enable the second node 112 to determine which one or more areas may correspond to the GeoArea. That is, the second node 112 may then map the GeoArea indicated to a list of TAIs.

### Action 602

In a second group of embodiments, the sixth node 116 may not have included the first flag in the first previous request. The second node 112 may then need to check with the fifth node 115, via the first node 111 if narrowed mobility may apply to the group of devices 130.

With this purpose, in this Action 602, the second node 112 may send, responsive to the received first previous request, the first prior request to the first node 111. The first prior request may be to request the first prior information indicating whether or not the group of devices 130 may be restricted to operate in the limited group of areas. This Action 602 may be understood to be optional. The second node 112 may refrain from sending the first prior request to the first node 111 in the first group of embodiments, wherein the sixth node 116 may have included the first flag in the first previous request, so the second node 112 may already know that the group of devices 130 has narrowed mobility. The second node 112 may also refrain from sending the first prior request to the first node 111 in a third group embodiments, wherein the second node 112 may be configured with a respective flag, e.g., a respective fifth flag, per sixth node 116, that may indicate whether or not the requests from the respective sixth node 116 may need to be applied with a narrowed mobility. In addition, the narrowed mobility area may be as well configured in the second node 112, e.g., with a list of TAIs for the area.

The first prior request may be the Nudm_SubscriberDataManagement_Get request.

The first prior request may comprise the third flag, explicitly indicating that the first prior information requested is to indicate whether or not the group of devices 130 is restricted to operate in the limited group of areas.

The third flag may be the narrowed mobility data flag. The third flag may be in the Nudm_SubscriberDataManagement_Get request.

The first prior request may further indicate an identifier or identity (ID) of the group of devices 130, e.g., the ExternalGroupId.

By sending the first prior request to the first node 111 in this Action 602, the second node 112 may then be enabled to obtain the first prior information indicating whether or not the group of devices 130 may be restricted to operate in the limited group of areas from the fifth node 115 via the first node 111, as part of the information for the identifier for the group of devices 130, e.g., the External GroupId. This may require a new flag, the fourth flag, indicating “narrowed mobility”associated to the External Group Id in the fifth node 115.

### Action 603

In this Action 603, the second node 112 may receive, responsive to the sent first prior request, the second prior response from the first node 111. The second prior response may comprise the first prior information.

The second prior response may be the Nudm_SubscriberDataManagement_Get response.

The second prior response may comprise the fourth flag indicating whether or not the group of devices 130 may be restricted to operate in the limited group of areas.

By receiving the second prior response, the second node 112 may be enabled to identify if the first previous request may apply to devices with a narrowed mobility. When the fourth flag may be included in the second prior response, the second node 112, may then be enabled to include the first flag in the first request to the first node 111, which may inform the first node 111 about this narrowed mobility limitation.

The second prior response may further comprise the GeoArea. This may then enable the second node 112 to determine which one or more areas may correspond to the GeoArea. That is, the second node 112 may then map the GeoArea indicated to a list of TAIs.

### Action 604

In this Action 604, the second node 112 sends, responsive to the received first previous request, the first request to the first node 111 operating in the communications system 100. As described earlier, the first request is to receive the first information. The request comprises the first indication. The first indication indicates that the group of devices 130 is restricted to operate in the one or more areas covered by the communications system 100. The one or more areas are obtained by the second node 112.

In some embodiments, at least one of the following options may apply: a) the first indication may be the first flag in the subscription request; b) each of the one or more areas may be identified by a TAI, c) the one or more areas may be identified by the list of TAIs, d) the communications system 100 may be the 5G system, e) the first node 111 may be the UDM node, f) the second node 112 may be the NEF node, g) the sixth node 116 may be the AF node, and h) the first previous request may be a Nnef_EventExposure_Subscribe request.

The first flag may be the narrowed-mobility flag in the Nnef_EventExposure_Subscribe request.

By sending in this Action 604 the first request, the second node 112 initiates a provision of the first information to the sixth node 116.

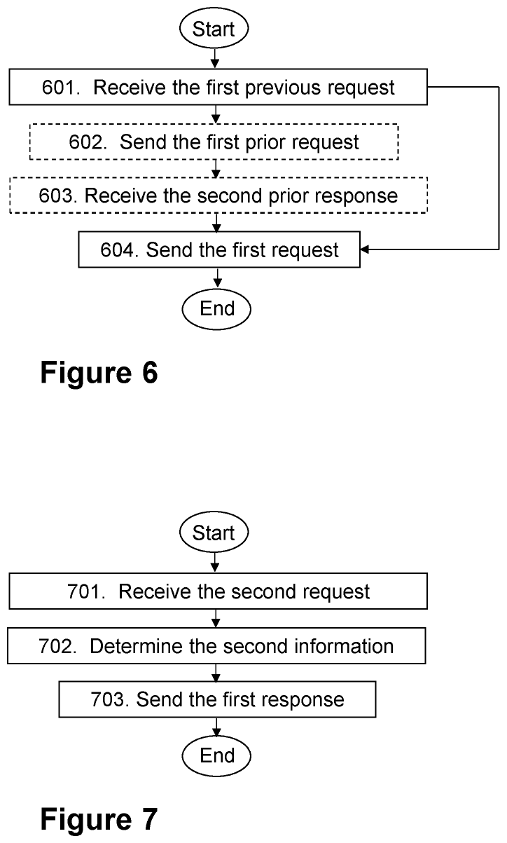

Embodiments of a computer-implemented method performed by the fourth node 114, will now be described with reference to the flowchart depicted in FIG. 7. The method may be understood to be for handling the information pertaining to the group of devices 130. The fourth node 114 operates in the communications system 100.

The method comprises the following actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, in some embodiments, the fourth node 114 may be the UDR, and the first node 111 may be the UDM.

### Action 701

In this Action 701, the fourth node 114 receives the second request from the first node 111 operating in the communications system 100. The second request requests to receive the second information regarding which one or more third nodes 113 serve at least one of the one or more areas indicated in the second request.

Each of the one or more areas may be identified by a TAI.

In some embodiments, the one or more areas may be identified by the list of TAIs.

The second request may comprise the second flag explicitly indicating that the second information is to be regarding which one or more third nodes 113 serve at least one of the indicated one or more areas.

The receiving of the first prior request may be performed e.g., via the second link 152.

In some embodiments, the communications system 100 may be the 5G system.

In some embodiments, the first node 111 may be the UDM. The fourth node 114 may be the NRF node. Each of the one or more third nodes 113 may be an AMF node.

The second request may be the Nnrf_NFDiscovery_NFDiscover request.

The second flag may be the Nnrf_NFDiscover flag. This may be the case in embodiments wherein the first node 111 may be the UDM and the fourth node 114 may be the NRF.

The second flag may be an “at least one” flag or a flag with a different denomination but the same functionality.

In particular examples, the second request may comprise the second flag, the indication of the one or more areas, e.g., the TAI list, and a further indication of a type of the target network function, e.g., “target-nf-type=AMF”.

### Action 702

The fourth node 114, in this Action 702, determines, responsive to the received second request, the second information. As described earlier, the fourth node 114 may search for the one or more third nodes 113 matching “at least one”TAI from the TAI list.

Determining may be understood as checking, calculating, deriving, matching, or similar.

### Action 703

The fourth node 114 then, in this Action 703, sends, in response to the received second request, the first response to the first node 111, the first response comprising the requested second information.

In some embodiments wherein the fourth indication may request provision of the address to which the notification may be sent, the fifth indication may indicate the indicated address.

The first response may be the Nnrf_NFDiscovery_NF Discover response.

The sending of the first response may be performed e.g., via the second link 152.

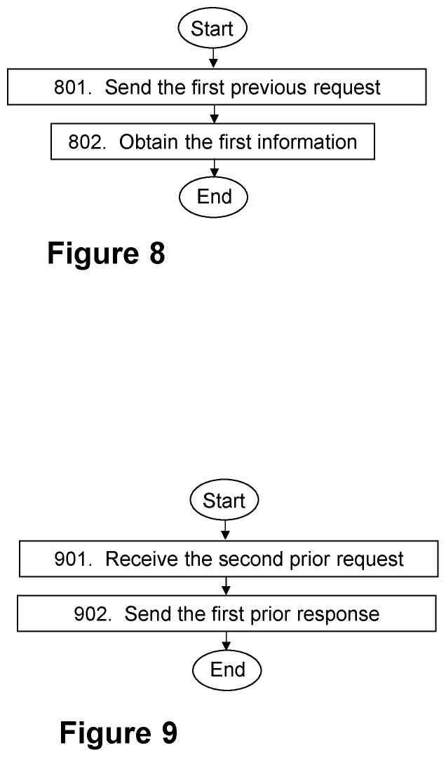

Embodiments of a computer-implemented method performed by the sixth node 116, will now be described with reference to the flowchart depicted in FIG. 8. The method may be understood to be for handling the information pertaining to the group of devices 130. The sixth node 116 operates with the communications system 100.

The method comprises the following actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, in some embodiments, the sixth node 116 may be the AF, and the second node 112 may be the NEF.

### Action 801

In this Action 801, the sixth node 116 sends the first previous request to the second node 112 operating with the communications system 100. The first previous request is to receive the first information pertaining to the event for the group of devices 130. The first previous request comprises the first indication. The first indication indicates that the group of devices 130 is restricted to operate in the one or more areas covered by the communications system 100. The one or more areas are indicated by the sixth node 116.

In some embodiments, at least one of the following options may apply: a) the first indication may be the first flag in the subscription request; b) each of the one or more areas may be identified by a TAI, c) the one or more areas may be identified by the list of TAIs, d) the communications system 100 may be the 5G system, e) the second node 112 may be the NEF node, f) the sixth node 116 may be the AF node, and g) the first previous request may be the Nnef_EventExposure_Subscribe request.

The first flag may be the narrowed-mobility flag in the Nnef_EventExposure_Subscribe request.

The first previous request may indicate the event with the another flag.

The first previous request may further indicate the ID of the group of devices 130, e.g., the ExternalGroupId.

Optionally, the first previous request may also indicate the information about which geographical area the narrowed mobility may correspond to, e.g., the first previous request may further comprise the GeoArea. This may then enable the second node 112 to determine which one or more areas may correspond to the GeoArea. That is, the second node 112 may then map the GeoArea indicated to a list of TAIs.

In the third group embodiments, the second node 112 may be configured with the respective flag per sixth node 116, that may enable the second node 112 to identify the sixth node 116 as sending requests for devices with the narrowed mobility. In addition, the narrowed mobility area may then be enabled to be derived by the second node 112, based on the GeoArea, and on the list of TAIs for the area that may be also configured in the second node 112.

The sending, in this Action 801 may be performed, e.g., via the fifth link 155.

### Action 802

The sixth node 116, in this Action 802, obtains the first information responsive to the sent first previous request. That is, the sixth node 116 may receive one or more notifications of the event concerning the group of devices 130, from the pertinent one or more third nodes 113, via the second node 112, or via the second node 112 and the first node 111.

Obtaining may be understood as e.g., receiving.

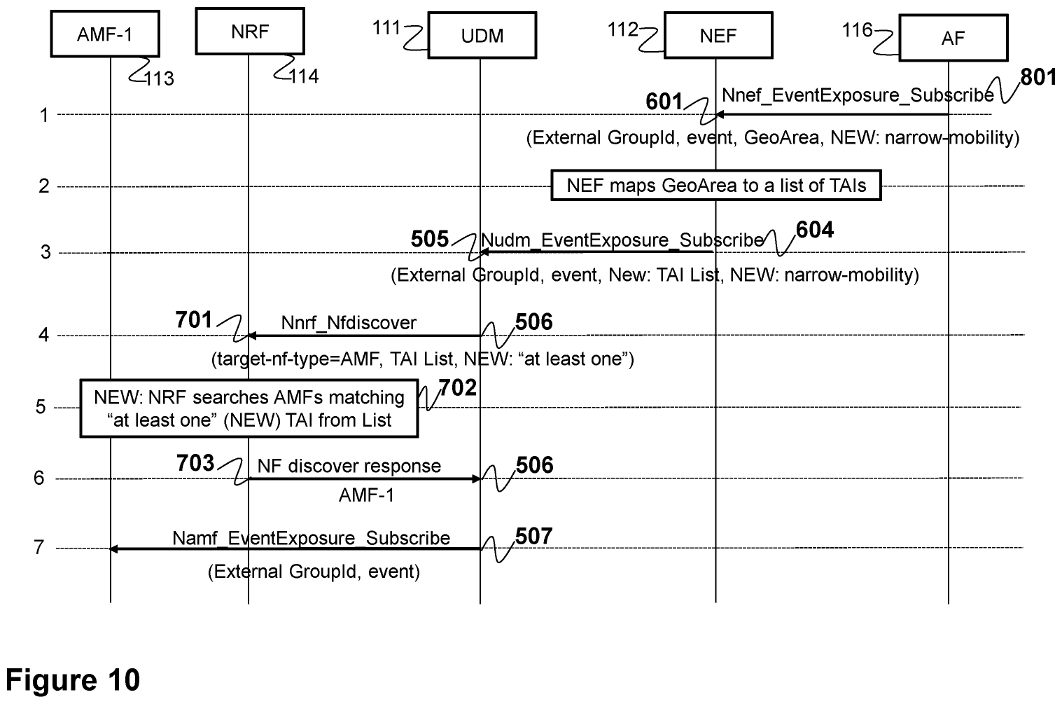

Embodiments of a computer-implemented method performed by the fifth node 115, will now be described with reference to the flowchart depicted in FIG. 9. The method may be understood to be for handling the information pertaining to the group of devices 130. The fifth node 115 operates in the communications system 100.

In some embodiments, the communications system 100 may be the 5G system.

The method comprises the following actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, in some embodiments, the fifth node 115 may be the UDR. The first node 111 may be the UDM.

### Action 901

In this Action 901, the fifth node 115 receives the second prior request from the first node 111 operating in the communications system 100. The second prior request requests the first prior information. The first prior information indicates whether or not the group of devices 130 is restricted to operate in the limited group of areas.

The second prior request may be the Nudr_DataRepository_Query request.

The second prior request may also comprise the third flag explicitly indicating that the first prior information requested is to indicate whether or not the group of devices 130 is restricted to operate in the limited group of areas.

The third flag may be a narrowed mobility data flag. The third flag may be in the Nudm_SubscriberDataManagement_Get request.

Each of the one or more areas may be identified by a TAI.

The second prior request may further indicate the ID of the group of devices 130, e.g., the ExternalGroupId.

The receiving, in this Action 901 may be performed, e.g., via the sixth link 156.

### Action 902

The fifth node 115, in this Action 902, sends, in response to the received second prior request, the first prior response to the first node 111. The first prior response comprises the requested first prior information.

The first prior response may comprise the fourth flag indicating whether or not the group of devices 130 may be restricted to operate in the limited group of areas.

The first prior response may be a Nudr_DataRepository_Query response. This may be in embodiments wherein the first node 111 may be the UDM node and the fifth node 115 may be the UDR.

The fourth flag may be the narrowed-mobility indication, e.g., in the Nudr_DataRepository_Query response. The fourth flag may be the same as the third flag.

The first prior response may further comprise the GeoArea.

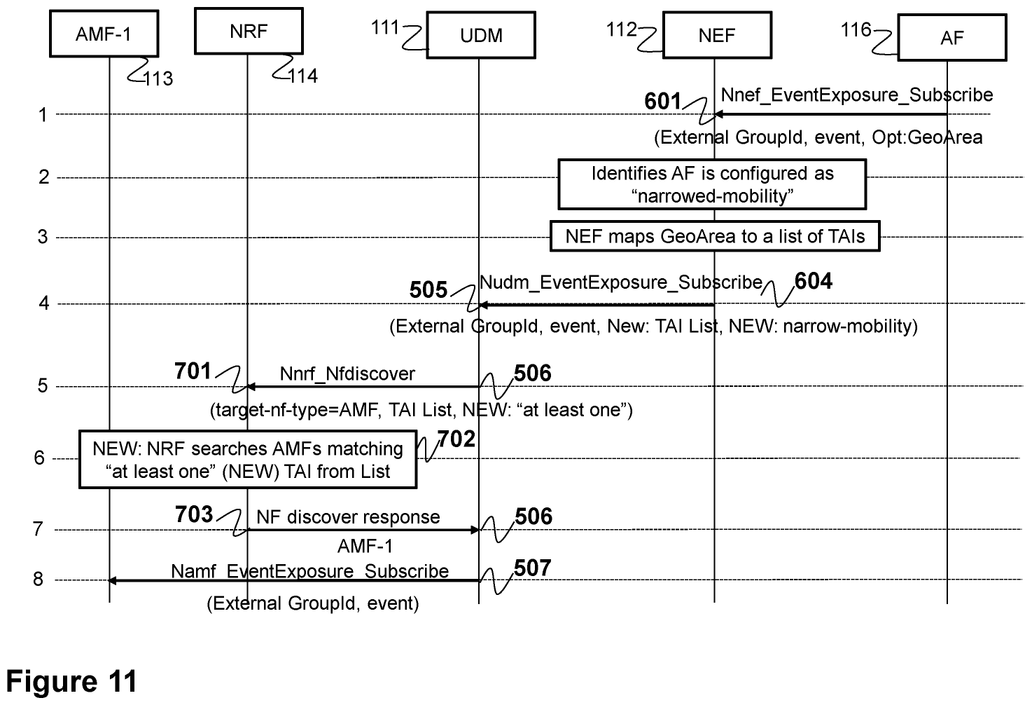

Several non-limiting examples of a method in the communications system 100 according to embodiments herein will now be described in the next FIGS. 10-12. In FIGS. 10-12, the communications system 100 is a 5G network, the first node 111 is a UDM, the second node is a NEF, each of the one or more third nodes 113 is an AMF, e.g., AMF-1, the fourth node 114 is an NRF, the fifth node 115 is a UDR, and the sixth node 116 is an AF. It may be understood that in the following examples depicted in FIG. 10-12, any reference to the UDM may be understood to equally refer to the first node 111, any reference to the NEF may be may be understood to equally refer to the second node 112, any reference to the AMF-1 may be may be understood to equally refer to the one or more third nodes 113, any reference to the NRF may be may be understood to equally refer to the fourth node 114, any reference to the UDR may be may be understood to equally refer to the fifth node 115, and any reference to the AF may be may be understood to equally refer to the sixth node 116.

FIG. 10 is a signalling diagram depicting a first non-limiting example of a method performed in the communications system 100, according to embodiments herein. The example of FIG. 10 depicts an example of the variant of the first group of embodiments, wherein the AF may provide the narrowed-mobility indication as the first flag. In Step 1, the AF may, according to Action 901 and Action 501, send the first previous request, in this example for EventExposurethat may apply to the group of devices 130, that is, a Group of UEs, identified by External GroupId, for an Event, e.g., UE location change. The first previous request includes geographical area, that is new in this request, but that is already defined for other procedures in existing methods. The first previous request further includes the first flag, a “narrowed-mobility” flag, to indicate that the first previous request applies with restricted/reduced/limited mobility, that is, it would apply to one or multiple TAIs. The first previous request is a Nnef_EventExposure_Subscribe. In Step 2, the NEF may map the GeoArea to a list of TAIs. This is new in this procedure, but this task may be already executed by a NEF in other procedures, see, e.g., [1]. In Step 3, the NEF may, according to Action 604 and Action 505, send a Nudm_EventExposure_Subscribe request to the UDM. As a result of the “narrowed-mobility” flag received in Step 1, the NEF may include the same flag in the request. The TAI List may be also included. The first request also includes the External GroupId and the indication of the event. The UDM may need to discover the affected AMFs, to be able to send the EventExposure request to them. For that, in Step 4, in accordance with Action 506 and Action 701, the UDM may send an Nnrf_Nfdiscover request to the NRF. The second request may include the second flag, that is, a new flag associated to the TAI List received, to indicate to the NRF that it has to provide results that match “at least one” of the TAIs in the List that may be also indicated in the second request. If the second flag would not be included, the NRF may provide a match only for AMFs that match all the TAIs in the List.

The second request also indicates that the one or more nodes 113 are AMFs by including the target-nf-type=AMF indication. In Step 5, in accordance with Action 702, the NRF performs the search for AMFs matching “at least one” TAI from the List. The NRF may be understood to take the “at least one” flag into account as indicated. In Step 6, in accordance with Action 703 and Action 506, only the AMFs that serve the narrowed mobility area are provided in an NF discover response, in this example, it is only AMF-1. In Step 7, the UDM is able to send, in accordance with Action 507, the Namf_EventExposure_Subscribe to only to the AMFs that serve the narrowed mobility area. The Namf_EventExposure_Subscribe may also include the another flag of the event and the External GroupID.

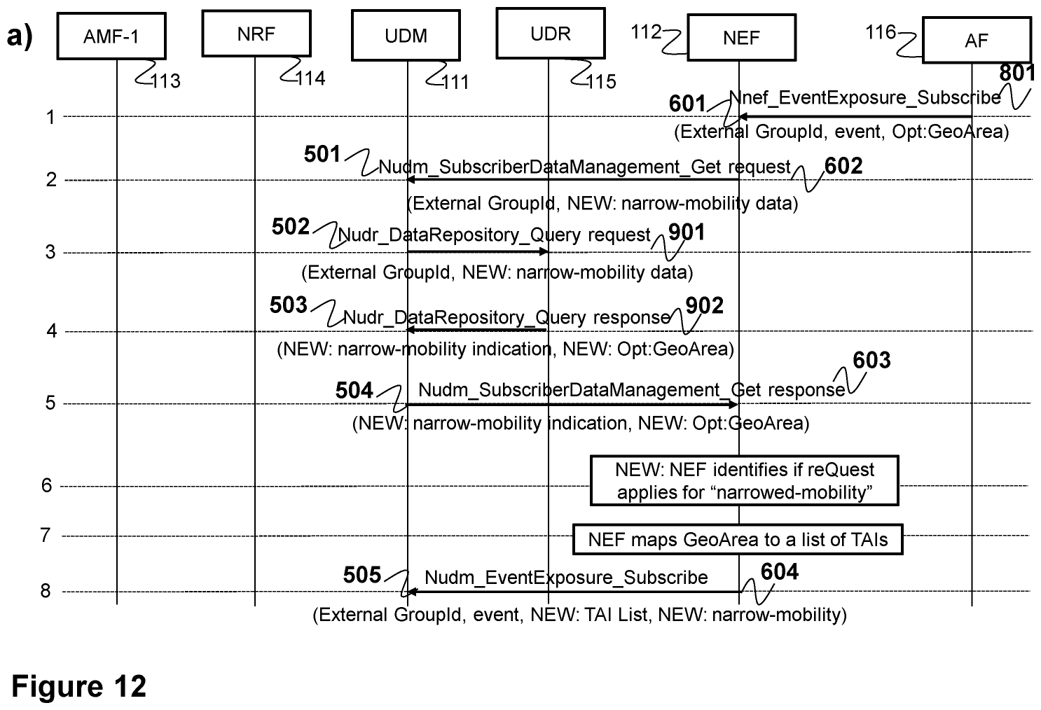

FIG. 11 is another signalling diagram depicting another non-limiting example of a method performed in the communications system 100, according to embodiments herein. The example of FIG. 6 depicts an example of the variant of the second group of embodiments, wherein the NEF may be configured with AF narrowed-mobility information. Step 1 is similar to Step 1 in FIG. 10, but in this case, the first flag, the “narrowed-mobility” flag may not be provided. This time, the “GeoArea” may be optionally included in the Nnef_EventExposure_Subscribe, along with the External GroupID. In Step 2, the NEF may be configured in order to identify that requests from this AF may be understood to apply for “narrowed-mobility”. In addition, the GeoArea of applicability of this “narrowed-mobility” may be configured. If that is the case, then if not provided in Step 1, the configured information may be used. The following steps may be understood to be similar to those of FIG. 10.

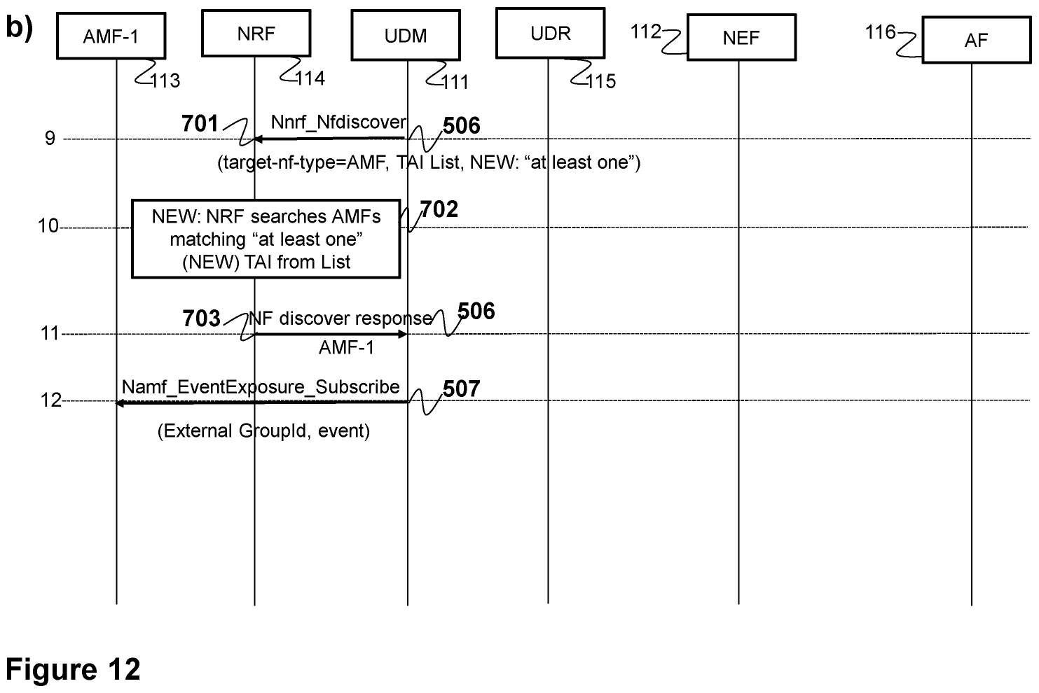

FIG. 12 is a signalling diagram depicting yet another non-limiting example of a method performed in the communications system 100, according to embodiments herein, over panels a), b) and c). The example of FIG. 12 depicts an example of the variant of the third group of embodiments, wherein the new narrowed-mobility information for the ExtGroupId may be stored in the UDR. Step 1 is similar to Step 1 in FIG. 10. In Steps 2-5, the NEF may need to check if narrowed-mobility may apply for the received External GroupId. For that it, the NEF may get External GroupId information stored in the UDR. As described earlier, the request may be sent via the UDM. This may require new data stored for the ExternalGroupId, that may include the indication, e.g., Boolean, of whether for narrowed-mobility may apply for this group of devices 130, e.g., this GroupID. In addition, the information about which GeoArea the narrowed mobility may correspond to, may be included as well as new data. In Step 2, according to Action 602 and Action 501, the NEF may send the first prior request as a Nudm_SubscriberDataManagement_Get request to the UDM. The first prior request may include the third flag, and the External GroupID. In Step 3, the UDM may, according to Action 502 and Action 901, send the second prior request to the UDR as a Nudr_DataRepository_Query request. The second prior request may include the third flag, and the External GroupID. In Step 4, the UDR may, according to Action 902 and Action 503, send the first prior response as a Nudr_DataRepository_Query response. The first prior response may comprise the fourth flag and optionally, the GeoArea. In Step 5, the UDM may, according to Action 504 and Action 603, send the second prior response to the NEF as a Nudm_SubscriberDataManagement_Get response. The second prior response may comprise the fourth flag and optionally, the GeoArea. In Step 6, based on the narrowed-indication returned for the requested External Group-Id, the NEF may identify whether the request may apply to a Group of UEs with narrowed-mobility. Optionally, if the GeoArea is not provided in Step 1, but it is provided in the response from the UDM/UDR, this GeoArea may be used in Step 7. The following steps may be understood to be similar to those of FIG. 10.

Certain embodiments disclosed herein may provide one or more of the following technical advantage(s), which may be summarized as follows.

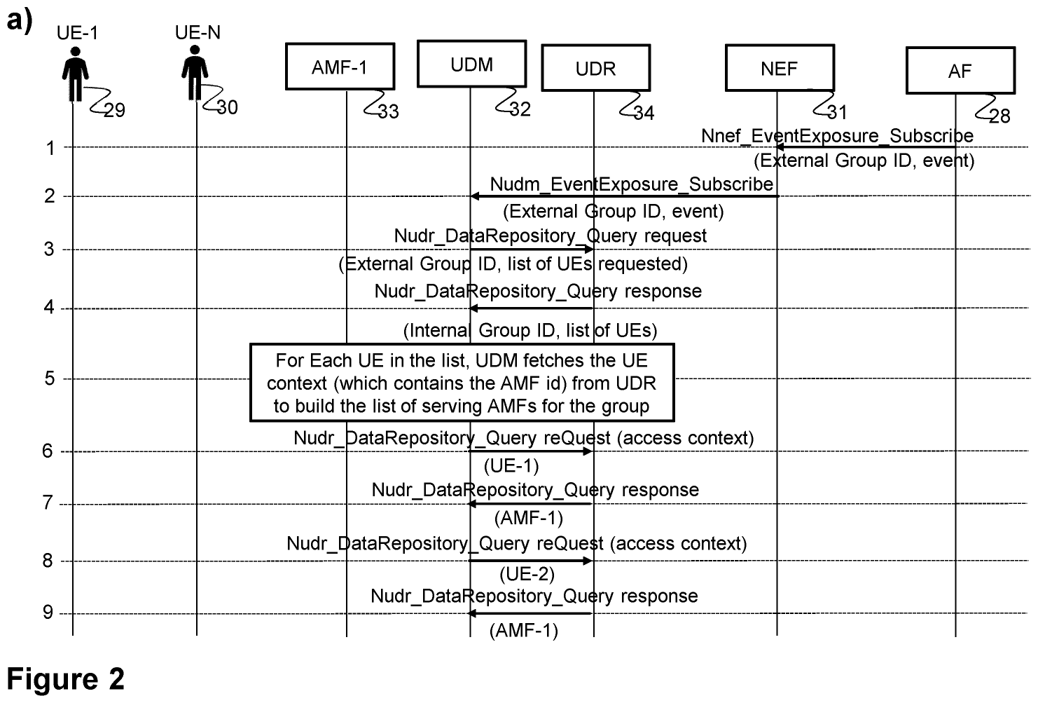

As a first advantage, embodiments herein may be understood to enable the communications system 100, e.g., a 5GC network, to consider the concept of narrowed mobility. This may in turn provide the following advantages. First, embodiments herein may enable to avoid the problems described in the Summary section as follows. With regards to the problem raised by the existing method of FIG. 2, embodiments herein may enable to avoid that the UDM performs a procedure to identify the list of AMFs that may serve the list of UEs that corresponds to the external Group Id. Thereby, signalling and processing resources may be saved.

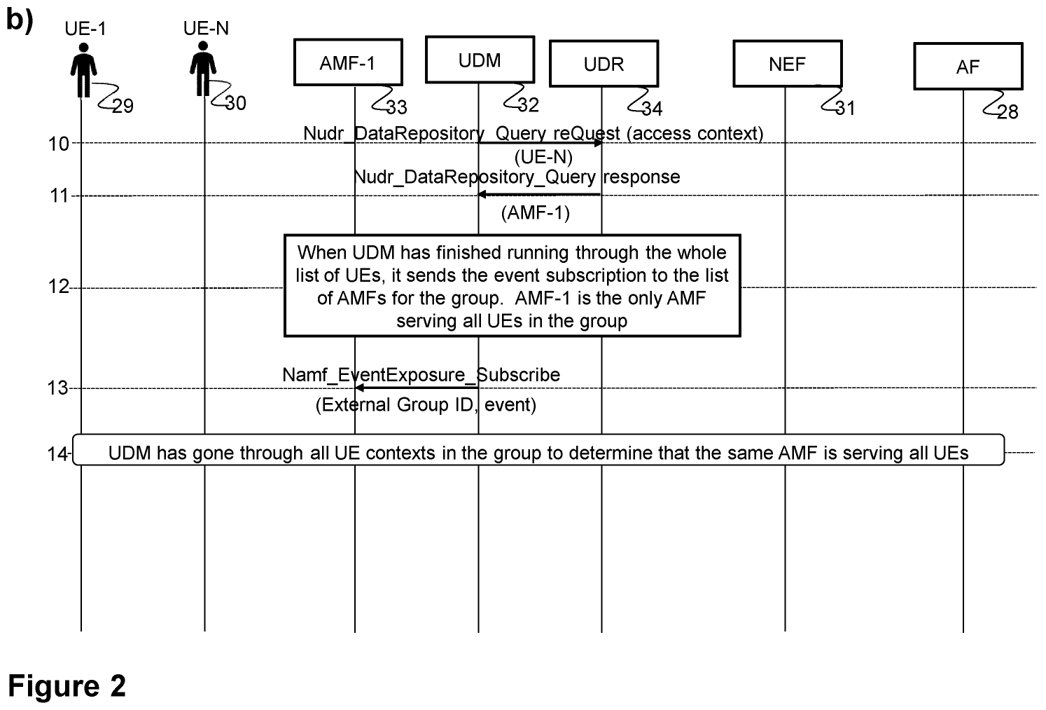

With regards to the problem raised by the existing method of FIG. 3, embodiments herein may enable to avoid contacting serving nodes, e.g., AMFs, which may not serve the area of operation of the group of devices 130, hence avoiding the reservation of resources which may never anyway be used in many serving nodes/AMFs. Resources may therefore be saved, and resource capacity for other activities may be increased.

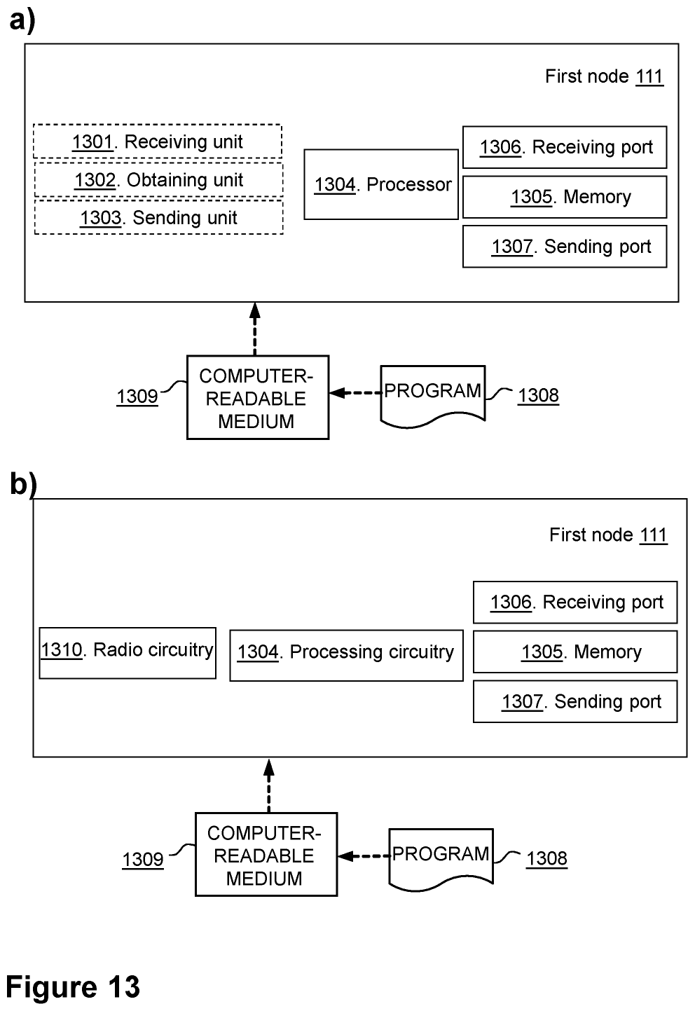

FIG. 13 depicts two different examples in panels a) and b), respectively, of the arrangement that the first node 111 may comprise to perform the method actions described above in relation to FIG. 5 and/or FIGS. 10-12. In some embodiments, the first node 111 may comprise the following arrangement depicted in FIG. 13a. The first node 111 may be understood to be for handling information configured to pertain to the group of devices 130. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 13, optional boxes are indicated by dashed lines. The detailed description of some of the following corresponds to the same references provided above, in relation to the actions described for the first node 111 and will thus not be repeated here. For example, in some embodiments, the first node 111 may be configured to be a UDM and the second node 112 may be configured to be a NEF.

The first node 111 is configured to, e.g., by means of a receiving unit 1301 within the first node 111 configured to, receive the first request from the second node 112 configured to operate in the communications system 100. The first request is configured to be to receive the first information configured to pertain to the event for the group of devices 130. The request is configured to comprise the first indication. The first indication is configured to indicate that the group of devices 130 is restricted to operate in the one or more areas configured to be covered by the communications system 100. The one or more areas are configured to be indicated by the second node 112.

The first node 111 is also configured to, e.g., by means of an obtaining unit 1302 within the first node 111 configured to, obtain, responsive to the received first request, the second information configured to be regarding which one or more third nodes 113 are configured to serve at least one of the indicated one or more areas.

The first node 111 may be also configured to, e.g., by means of a sending unit 1303 within the first node 111 configured to, send, responsive to the obtained second information, the respective additional request to the one or more third nodes 113. The respective additional request is configured to request to receive the first information for the group of devices 130.

In some embodiments, the first node 111 may be further configured to, e.g., by means of the receiving unit 1301 within the first node 111 configured to, receive the first prior request from the second node 112. The first prior request is configured to request the first prior information configured to indicate whether or not the group of devices 130 may be restricted to operate in the limited group of areas.

In some embodiments, the first node 111 may be further configured to, e.g., by means of the sending unit 1303 within the first node 111 configured to, send, responsive to the received first prior request, the second prior request to the fifth node 115 configured to operate in the communications system 100. The second prior request may be configured to request the first prior information.

In some embodiments, the first node 111 may be further configured to, e.g., by means of the receiving unit 1301 within the first node 111 configured to, receive, in response to the sent second prior request, from the fifth node 115, the first prior response configured to comprise the requested first prior information.

In some embodiments, the first node 111 may be further configured to, e.g., by means of the sending unit 1303 within the first node 111 configured to, send, responsive to the received first prior response, the second prior response to the second node 112. The second prior response may be configured to comprise the first prior information. The received first request may be configured to be based on the sent second prior response.

In some embodiments, the obtaining of the second information may be configured to comprise: a) sending, responsive to the received first request, the second request to the fourth node 114 configured to operate in the communications system 100; the second request may be configured to request to receive the second information, and b) receiving, responsive to the sent second request, the first response configured to comprise the requested second information.

In some embodiments, at least one of the following may apply: a) the first indication may be configured to be the first flag in the subscription request, b) each of the one or more areas may be configured to be identified by a TAI, c) the one or more areas may be configured to be identified by the list of TAIs, d) the communications system 100 may be configured to be the 5G system, e) the first node 111 may be configured to be the UDM node, f) the second node 112 may be configured to be the NEF node, g) the fourth node 114 may be configured to be the NRF node, h) each of the one or more third nodes 113 may be configured to be an AMF node, i) the first request may be configured to be the Nudm_EventExposure_Subscribe message, j) the second request may be configured to be the Nnrf_NFDiscovery_NFDiscover request, k) the second request may be configured to comprise the second flag configured to explicitly indicate that the second information is to be regarding which one or more third nodes 113 may serve at least one of the indicated one or more areas, l) the second flag may be configured to be the Nnrf_NFDiscover flag, m) the first response may be configured to be the Nnrf_NFDiscovery_NF Discover response, and n) each respective additional request may be configured to be the Namf_EventExposure_Subscribe request.

In some embodiments, the first flag may be configured to be the narrowed-mobility flag in the Nnef_EventExposure_Subscribe request.

In some embodiments, at least one of the following may apply: a) the fifth node 115 may be configured to be the UDR, b) the first prior request may be configured to be the Nudm_SubscriberDataManagement_Get request, c) the first prior request may be configured to comprise the third flag configured to explicitly indicate that the first prior information requested is to indicate whether or not the group of devices 130 may be restricted to operate in the limited group of areas, d) the third flag may be configured to be the narrowed mobility data flag in the Nudm_SubscriberDataManagement_Get request, e) the second prior request may be configured to be the Nudr_DataRepository_Query request, f) the first prior response may be configured to be the Nudr_DataRepository_Query response, g) the second prior request may be configured to comprise the third flag, h) the second prior request may be configured to further comprise a GeoArea, i) the second prior response may be configured to be the Nudm_SubscriberDataManagement_Get response, j) the second prior response may be further configured to comprise the GeoArea, k) any of the first prior response and the second prior response may be configured to comprise the fourth flag configured to indicate whether or not the group of devices 130 may be restricted to operate in the limited group of areas, l) the fourth flag in the first prior response may be configured to be the narrowed-mobility indication in the Nudr_DataRepository_Query response, m) the fourth flag in the second prior response may be configured to be the narrowed-mobility indication in the Nudm_SubscriberDataManagement_Get response, and n) the first prior response may be further configured to comprise the GeoArea.

The embodiments herein may be implemented through one or more processors, such as a processor 1304 in the first node 111 depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1305 comprising one or more memory units. The memory 1305 is arranged to be used to store obtained information, store data, configurations, schedulings, and applications etc. to perform the methods herein when being executed in the first node 111.

In some embodiments, the first node 111 may receive information from, e.g., the second node 112, the one or more third nodes 113, the fourth node 114, the fifth node 115, the sixth node 116, the group of one or more devices 130, and/or another node through a receiving port 1306. In some examples, the receiving port 1306 may be, for example, connected to one or more antennas in the first node 111. In other embodiments, the first node 111 may receive information from another structure in the communications system 100 through the receiving port 1306. Since the receiving port 1306 may be in communication with the processor 1304, the receiving port 1306 may then send the received information to the processor 1304. The receiving port 1306 may also be configured to receive other information.

The processor 1304 in the first node 111 may be further configured to transmit or send information to e.g., the second node 112, the one or more third nodes 113, the fourth node 114, the fifth node 115, the sixth node 116, the group of one or more devices 130, another node and/or another structure in the communications system 100, through a sending port 1307, which may be in communication with the processor 1304, and the memory 1305.

Those skilled in the art will also appreciate that any of the units 1301-1303 described above may refer to a combination of analog and digital circuits, and/or one or more processors configured with software and/or firmware, e.g., stored in memory, that, when executed by the one or more processors such as the processor 1304, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1301-1304 described above may be the processor 1303 of the first node 111, or an application running on such processor.

Thus, the methods according to the embodiments described herein for the first node 111 may be respectively implemented by means of a computer program 1308 product, comprising instructions, i.e., software code portions, which, when executed on at least one processor 1304, cause the at least one processor 1304 to carry out the actions described herein, as performed by the first node 111. The computer program 1308 product may be stored on a computer-readable storage medium 1309. The computer-readable storage medium 1309, having stored thereon the computer program 1308, may comprise instructions which, when executed on at least one processor 1304, cause the at least one processor 1304 to carry out the actions described herein, as performed by the first node 111. In some embodiments, the computer-readable storage medium 1309 may be a non-transitory computer-readable storage medium, such as a CD ROM disc, a memory stick, or stored in the cloud space. In other embodiments, the computer program 1308 product may be stored on a carrier containing the computer program, wherein the carrier is one of an electronic signal, optical signal, radio signal, or the computer-readable storage medium 1309, as described above.

The first node 111 may comprise an interface unit to facilitate communications between the first node 111 and other nodes or devices, e.g., the second node 112, the one or more third nodes 113, the fourth node 114, the fifth node 115, the sixth node 116, the group of one or more devices 130, another node and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 13b. The first node 111 may comprise a processing circuitry 1304, e.g., one or more processors such as the processor 1304, in the first node 111 and the memory 1305. The first node 111 may also comprise a radio circuitry 1310, which may comprise e.g., the receiving port 1306 and the sending port 1307. The processing circuitry 1304 may be configured to, or operable to, perform the method actions according to FIG. 5 and/or FIGS. 10-12, in a similar manner as that described in relation to FIG. 13a. The radio circuitry 1310 may be configured to set up and maintain at least a wireless connection with the second node 112, the one or more third nodes 113, the fourth node 114, the fifth node 115, the sixth node 116, the group of one or more devices 130, another node and/or another structure in the communications system 100.

Hence, embodiments herein also relate to the first node 111 operative for handling the information configured to pertain to the group of devices 130, the first node 111 being operative to operate in the communications system 100. The first node 111 may comprise the processing circuitry 1304 and the memory 1305, said memory 1305 containing instructions executable by said processing circuitry 1304, whereby the first node 111 is further operative to perform the actions described herein in relation to the first node 111, e.g., in FIG. 5 and/or FIGS. 10-12.

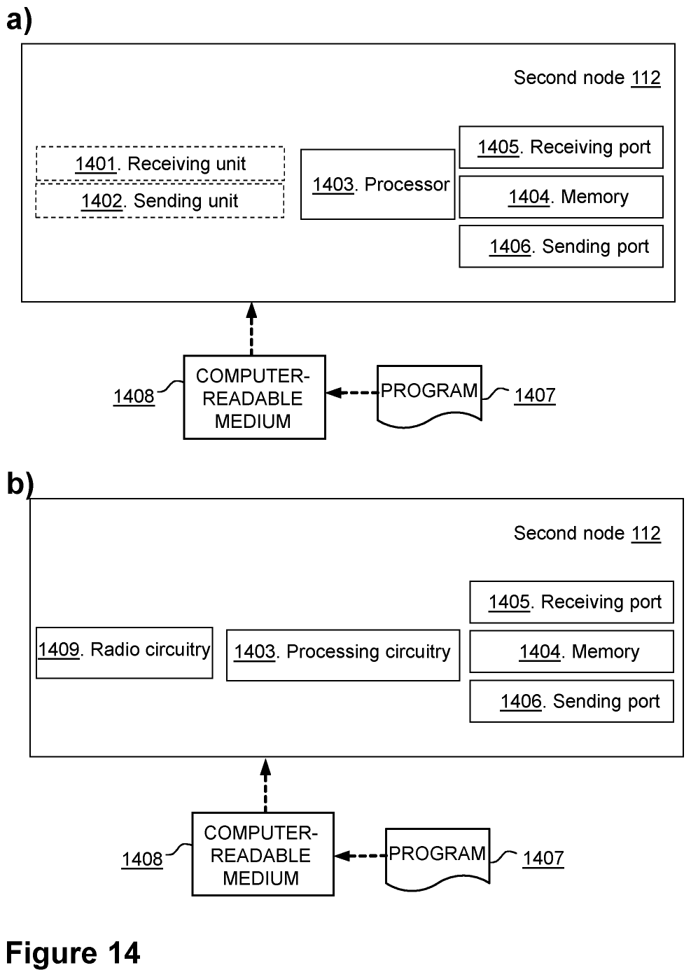

FIG. 14 depicts two different examples in panels a) and b), respectively, of the arrangement that the second node 112, may comprise to perform the method actions described above in relation to FIG. 6 and/or FIGS. 10-12. In some embodiments, the second node 112 may comprise the following arrangement depicted in FIG. 14a. The second node 112 may be understood to be for handling the information configured to pertain to the group of devices 130. The second node 112 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 14, optional boxes are indicated by dashed lines. The detailed description of some of the following corresponds to the same references provided above, in relation to the actions described for the second node 112 and will thus not be repeated here. For example, in some embodiments, second node 112 may be configured to be the NEF, and the first node 111 may be configured to be the UDM.

The second node 112 is configured to, e.g., by means of a receiving unit 1401 within the second node 112 configured to, receive the first previous request from the sixth node 116 configured to operate with the communications system 100. The first previous request is configured to be to receive the first information configured to pertain to the event for the group of devices 130.

The second node 112 is also configured to, e.g., by means of a sending unit 1402 within the second node 112 configured to, send, responsive to the received first previous request, the first request to the first node 111 configured to operate in the communications system 100. The first request is configured to be to receive the first information. The request is configured to comprise the first indication. The first indication is configured to indicate that the group of devices 130 is restricted to operate in the one or more areas configured to be covered by the communications system 100. The one or more areas are configured to be obtained by the second node 112. By sending the first request, the second node 112 is configured to initiate the provision of the first information to the sixth node 116.

In some embodiments, the second node 112 may be further configured to, e.g., by means of the sending unit 1402 within the second node 112 further configured to, send, responsive to the received first previous request, the first prior request to the first node 111. The first prior request may be configured to be to request the first prior information configured to indicate whether or not the group of devices 130 may be configured to be restricted to operate in the limited group of areas.

In some embodiments, the second node 112 may be further configured to, e.g., by means of the receiving unit 1401 within the second node 112 further configured to, receive, responsive to the sent first prior request, the second prior response from the first node 111. The second prior response may be configured to comprise the first prior information. The sent first request may be configured to be based on the received second prior response.

In some embodiments, at least one of the following may apply: a) the first indication may be configured to be the first flag in the subscription request, b) each of the one or more areas may be configured to be identified by a TAI, c) the one or more areas may be configured to be identified by the list of TAIs, d) the communications system 100 may be configured to be the 5G system, e) the first node 111 may be configured to be the UDM node, f) the second node 112 may be configured to be the NEF node, g) the sixth node 116 may be configured to be the AF node, h) the first previous request may be configured to be the Nnef_EventExposure_Subscribe request.

In some embodiments, the first flag may be configured to be the narrowed-mobility flag in the Nudm_EventExposure_Subscribe request.

In some embodiments, at least one of the following may apply: a) the first prior request may be configured to be the Nudm_SubscriberDataManagement_Get request, b) the first prior request may be configured to comprise the third flag configured to explicitly indicate that the first prior information requested is configured to be to indicate whether or not the group of devices 130 may be restricted to operate in the limited group of areas, c) the third flag may be configured to be the narrowed mobility data flag in the Nudm_SubscriberDataManagement_Get request, d) the second prior response may be configured to be the Nudm_SubscriberDataManagement_Get response, e) the second prior response may be configured to comprise the fourth flag configured to indicate whether or not the group of devices 130 may be restricted to operate in the limited group of areas, and f) the second prior response may be further configured to comprise the GeoArea,

The embodiments herein may be implemented through one or more processors, such as a processor 1403 in the second node 112 depicted in FIG. 14, together with computer program code for performing the functions and actions of the embodiments herein. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1404 comprising one or more memory units. The memory 1404 is arranged to be used to store obtained information, store data, configurations, schedulings, and applications etc. to perform the methods herein when being executed in the second node 112.

In some embodiments, the second node 112 may receive information from, e.g., the first node 111, the one or more third nodes 113, the fourth node 114, the fifth node 115, the sixth node 116, the group of one or more devices 130, and/or another node, through a receiving port 1405. In some examples, the receiving port 1405 may be, for example, connected to one or more antennas in the second node 112. In other embodiments, the second node 112 may receive information from another structure in the communications system 100 through the receiving port 1405. Since the receiving port 1405 may be in communication with the processor 1403, the receiving port 1405 may then send the received information to the processor 1403. The receiving port 1405 may also be configured to receive other information. The processor 1403 in the second node 112 may be further configured to transmit or send information to e.g., the first node 111, the one or more third nodes 113, the fourth node 114, the fifth node 115, the sixth node 116, the group of one or more devices 130, another node and/or another structure in the communications system 100, through a sending port 1406, which may be in communication with the processor 1403, and the memory 1404.

Those skilled in the art will also appreciate that any of the units 1401-1402 described above may refer to a combination of analog and digital circuits, and/or one or more processors configured with software and/or firmware, e.g., stored in memory, that, when executed by the one or more processors such as the processor 1403, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1401-1402 described above may be the processor 1403 of the second node 112, or an application running on such processor.

Thus, the methods according to the embodiments described herein for the second node 112 may be respectively implemented by means of a computer program 1407 product, comprising instructions, i.e., software code portions, which, when executed on at least one processor 1403, cause the at least one processor 1403 to carry out the actions described herein, as performed by the second node 112. The computer program 1407 product may be stored on a computer-readable storage medium 1408. The computer-readable storage medium 1408, having stored thereon the computer program 1407, may comprise instructions which, when executed on at least one processor 1403, cause the at least one processor 1403 to carry out the actions described herein, as performed by the second node 112. In some embodiments, the computer-readable storage medium 1408 may be a non-transitory computer-readable storage medium, such as a CD ROM disc, a memory stick, or stored in the cloud space. In other embodiments, the computer program 1407 product may be stored on a carrier containing the computer program, wherein the carrier is one of an electronic signal, optical signal, radio signal, or the computer-readable storage medium 1408, as described above.

The second node 112 may comprise an interface unit to facilitate communications between the second node 112 and other nodes or devices, e.g., the first node 111, the one or more third nodes 113, the fourth node 114, the fifth node 115, the sixth node 116, the group of one or more devices 130, another node and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 14b. The second node 112 may comprise a processing circuitry 1403, e.g., one or more processors such as the processor 1403 in the second node 112 and the memory 1404. The second node 112 may also comprise a radio circuitry 1409, which may comprise e.g., the receiving port 1405 and the sending port 1406. The processing circuitry 1403 may be configured to, or operable to, perform the method actions according to FIG. 6 and/or FIGS. 10-12, in a similar manner as that described in relation to FIG. 14a. The radio circuitry 1409 may be configured to set up and maintain at least a wireless connection with the first node 111, the one or more third nodes 113, the fourth node 114, the fifth node 115, the sixth node 116, the group of one or more devices 130, another node and/or another structure in the communications system 100.

Hence, embodiments herein also relate to the second node 112 operative for handling the information configured to pertain to the group of devices 130, the second node 112 being operative to operate in the communications system 100. The second node 112 may comprise the processing circuitry 1403 and the memory 1404, said memory 1404 containing instructions executable by said processing circuitry 1403, whereby the second node 112 is further operative to perform the actions described herein in relation to the second node 112, e.g., in FIG. 6 and/or FIGS. 10-12.

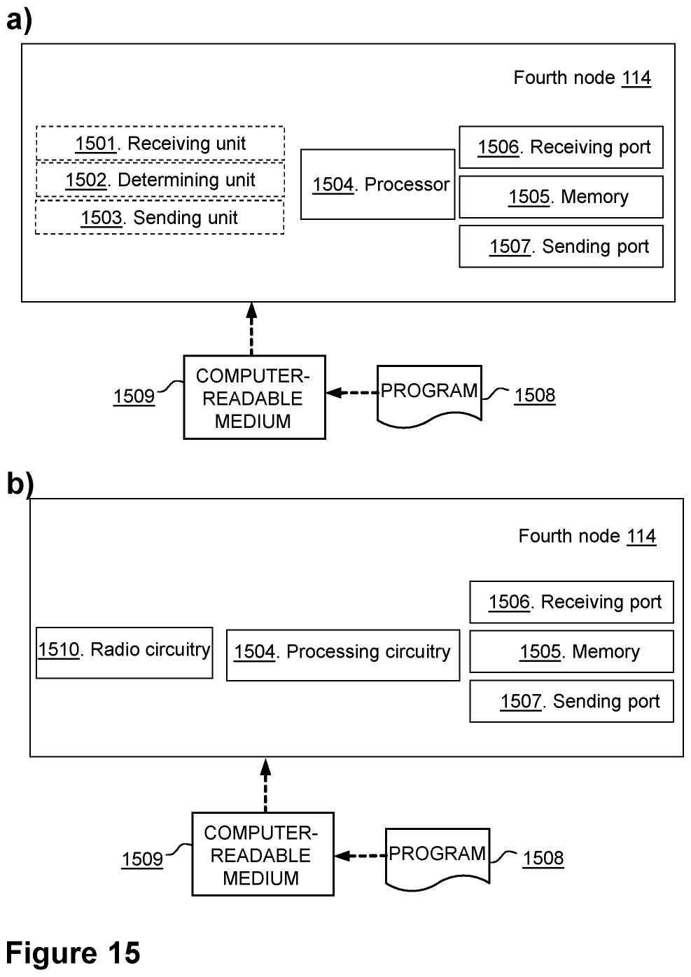

FIG. 15 depicts two different examples in panels a) and b), respectively, of the arrangement that the fourth node 114, may comprise to perform the method actions described above in relation to FIG. 7 and/or FIGS. 10-12. In some embodiments, the fourth node 114 may comprise the following arrangement depicted in FIG. 15a. The fourth node 114 may be understood to be for handling the information configured to pertain to the group of devices 130. The fourth node 114 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 15, optional boxes are indicated by dashed lines. The detailed description of some of the following corresponds to the same references provided above, in relation to the actions described for the fourth node 114 and will thus not be repeated here. For example, in some embodiments, the fourth node 114 may be configured to be the NRF, and the first node 111 may be configured to be the UDM.

The fourth node 114 is configured to, e.g., by means of a receiving unit 1501 within the fourth node 114 configured to, receive the second request from the first node 111 configured to operate in the communications system 100. The second request is configured to request to receive the second information configured to be regarding which one or more third nodes 113 are configured to serve at least one of the one or more areas configured to be indicated in the second request.

The fourth node 114 is also configured to, e.g., by means of a determining unit 1502 within the fourth node 114 configured to, determine, responsive to the received second request, the second information.

The fourth node 114 is further configured to, e.g., by means of a sending unit 1503 within the fourth node 114 configured to, send, in response to the received second request, the first response to the first node 111. the first response is configured to comprise the requested second information.

In some embodiments, at least one of the following may apply: a) each of the one or more areas may be configured to be identified by a TAI, b) the one or more areas may be configured to be identified by the list of TAIs, c) the communications system 100 may be configured to be the 5G system, d) the first node 111 may be configured to be the UDM node, e) the fourth node 114 may be configured to be the NRF node, f) each of the one or more third nodes 113 may be configured to be an AMF node, g) the second request may be configured to comprise the second flag configured to explicitly indicate that the second information is to be regarding which one or more third nodes 113 may be configured to serve at least one of the indicated one or more areas, h) the second request may be configured to be the Nnrf_NFDiscovery_NFDiscover request, i) the second flag may be configured to be the Nnrf_NFDiscover flag, and j) the first response may be configured to be the Nnrf_NFDiscovery_NF Discover response.

The embodiments herein may be implemented through one or more processors, such as a processor 1504 in the fourth node 114 depicted in FIG. 15, together with computer program code for performing the functions and actions of the embodiments herein. The program code mentioned above may also be provided as a computer program product, for instance in the form of a data carrier carrying computer program code for performing the embodiments herein when being loaded into the fourth node 114. One such carrier may be in the form of a CD ROM disc. It is however feasible with other data carriers such as a memory stick. The computer program code may furthermore be provided as pure program code on a server and downloaded to the fourth node 114.

The fourth node 114 may further comprise a memory 1505 comprising one or more memory units. The memory 1505 is arranged to be used to store obtained information, store data, configurations, schedulings, and applications etc. to perform the methods herein when being executed in the fourth node 114.

In some embodiments, the fourth node 114 may receive information from, e.g., the first node 111, the second node 112, the one or more third nodes 113, the fifth node 115, the sixth node 116, the group of one or more devices 130, and/or another node, through a receiving port 1506. In some examples, the receiving port 1506 may be, for example, connected to one or more antennas in the fourth node 114. In other embodiments, the fourth node 114 may receive information from another structure in the communications system 100 through the receiving port 1506. Since the receiving port 1506 may be in communication with the processor 1504, the receiving port 1506 may then send the received information to the processor 1504. The receiving port 1506 may also be configured to receive other information.

The processor 1504 in the fourth node 114 may be further configured to transmit or send information to e.g., the first node 111, the second node 112, the one or more third nodes 113, the fifth node 115, the sixth node 116, the group of one or more devices 130, another node and/or another structure in the communications system 100, through a sending port 1507, which may be in communication with the processor 1504, and the memory 1505.

Those skilled in the art will also appreciate that any of the units 1501-1503 described above may refer to a combination of analog and digital circuits, and/or one or more processors configured with software and/or firmware, e.g., stored in memory, that, when executed by the one or more processors such as the processor 1504, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1501-1503 described above may be the processor 1504 of the fourth node 114, or an application running on such processor.

Thus, the methods according to the embodiments described herein for the fourth node 114 may be respectively implemented by means of a computer program 1508 product, comprising instructions, i.e., software code portions, which, when executed on at least one processor 1504, cause the at least one processor 1504 to carry out the actions described herein, as performed by the fourth node 114. The computer program 1508 product may be stored on a computer-readable storage medium 1509. The computer-readable storage medium 1509, having stored thereon the computer program 1508, may comprise instructions which, when executed on at least one processor 1504, cause the at least one processor 1504 to carry out the actions described herein, as performed by the fourth node 114. In some embodiments, the computer-readable storage medium 1509 may be a non-transitory computer-readable storage medium, such as a CD ROM disc, a memory stick, or stored in the cloud space. In other embodiments, the computer program 1508 product may be stored on a carrier containing the computer program, wherein the carrier is one of an electronic signal, optical signal, radio signal, or the computer-readable storage medium 1509, as described above.

The fourth node 114 may comprise an interface unit to facilitate communications between the fourth node 114 and other nodes or devices, e.g., the first node 111, the second node 112, the one or more third nodes 113, the fifth node 115, the sixth node 116, the group of one or more devices 130, another node and/or another structure in the communications system 100. In some particular examples, the interface may, for example, include a transceiver configured to transmit and receive radio signals over an air interface in accordance with a suitable standard.

In other embodiments, the fourth node 114 may comprise the following arrangement depicted in FIG. 15b. The fourth node 114 may comprise a processing circuitry 1504, e.g., one or more processors such as the processor 1504 in the fourth node 114 and the memory 1505. The fourth node 114 may also comprise a radio circuitry 1510, which may comprise e.g., the receiving port 1506 and the sending port 1507. The processing circuitry 1504 may be configured to, or operable to, perform the method actions according to FIG. 7 and/or FIGS. 10-12, in a similar manner as that described in relation to FIG. 15a. The radio circuitry 1510 may be configured to set up and maintain at least a wireless connection with the first node 111, the second node 112, the one or more third nodes 113, the fifth node 115, the sixth node 116, the group of one or more devices 130, another node and/or another structure in the communications system 100.

Hence, embodiments herein also relate to the fourth node 114 operative for handling information configured to pertain to a group of devices 130, the fourth node 114 being operative to operate in the communications system 100. The fourth node 114 may comprise the processing circuitry 1504 and the memory 1505, said memory 1505 containing instructions executable by said processing circuitry 1504, whereby the fourth node 114 is further operative to perform the actions described herein in relation to the fourth node 114, e.g., in FIG. 7 and/or FIGS. 10-12.

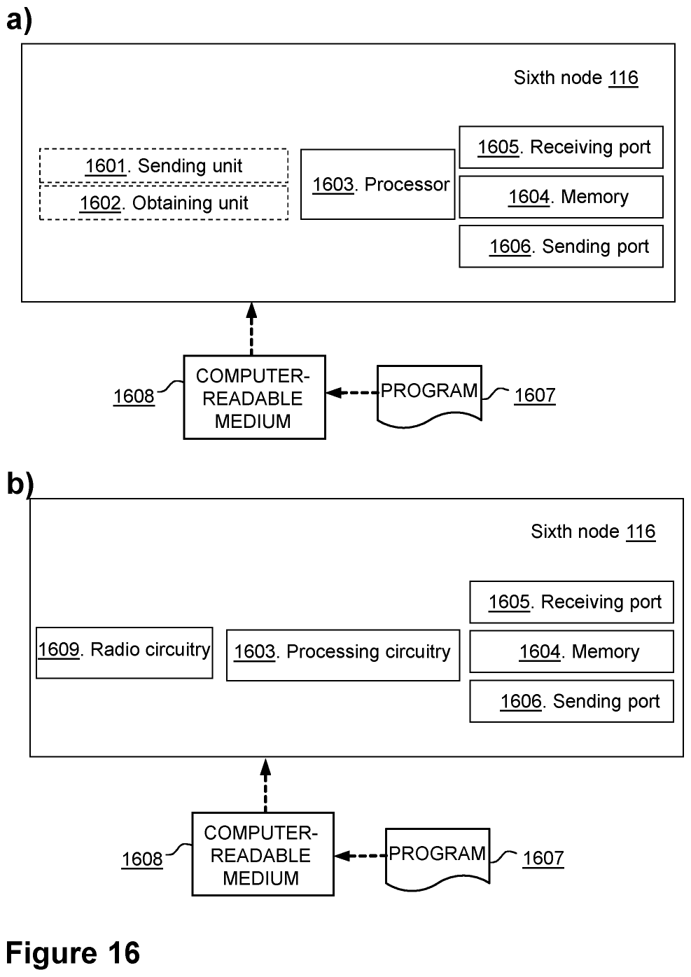

FIG. 16 depicts two different examples in panels a) and b), respectively, of the arrangement that the sixth node 116 may comprise to perform the method actions described above in relation to FIG. 8 and/or FIGS. 10-12. In some embodiments, the sixth node 116 may comprise the following arrangement depicted in FIG. 16a. The sixth node 116 may be understood to be for handling the information configured to pertain to the group of devices 130. The sixth node 116 is configured to operate with the communications system 100.

Several embodiments are comprised herein. Components from one embodiment may be tacitly assumed to be present in another embodiment and it will be obvious to a person skilled in the art how those components may be used in the other exemplary embodiments. In FIG. 16, optional boxes are indicated by dashed lines. The detailed description of some of the following corresponds to the same references provided above, in relation to the actions described for the sixth node 116 and will thus not be repeated here. For example, in some embodiments, the sixth node 116 may be configured to be the AF and the second node 112 may be configured to be the NEF.

The sixth node 116 is configured to, e.g., by means of a sending unit 1601 within the sixth node 116 configured to, send the first previous request to the second node 112 configured to operate with the communications system 100. The first previous request is configured to be to receive the first information configured to pertain to the event for the group of devices 130. The first previous request is configured to comprise the first indication. The first indication is configured to indicate that the group of devices 130 is restricted to operate in the one or more areas configured to be covered by the communications system 100. The one or more areas are configured to be indicated by the sixth node 116.

The sixth node 116 is also configured to, e.g., by means of an obtaining unit 1602 within the sixth node 116 configured to, obtain the first information responsive to the sent first previous request.

In some embodiments, at least one of the following may apply: a) the first indication may be configured to be the first flag in the subscription request, b) each of the one or more areas may be configured to be identified by a TAI, c) the one or more areas may be configured to be identified by the list of TAIs, d) the communications system 100 may be configured to be the 5G system, e) the second node 112 may be configured to be the NEF node, f) the sixth node 116 may be configured to be the AF node, g) the first previous request may be configured to be the Nnef_EventExposure_Subscribe request.

In some embodiments, the first flag may be configured to be the narrowed-mobility flag in the Nnef_EventExposure_Subscribe request.

The embodiments herein may be implemented through one or more processors, such as a processor 1603 in the sixth node 116 depicted in FIG. 16, together with computer program code for performing the functions and actions of the embodiments herein. The program code mentioned above may also be provided as a computer program product, for instance in the form of a data carrier carrying computer program code for performing the embodiments herein when being loaded into the sixth node 116. One such carrier may be in the form of a CD ROM disc. It is however feasible with other data carriers such as a memory stick. The computer program code may furthermore be provided as pure program code on a server and downloaded to the sixth node 116.

The sixth node 116 may further comprise a memory 1604 comprising one or more memory units. The memory 1604 is arranged to be used to store obtained information, store data, configurations, schedulings, and applications etc. to perform the methods herein when being executed in the sixth node 116.

In some embodiments, the sixth node 116 may receive information from, e.g., the first node 111, the second node 112, the one or more third nodes 113, the fourth node 114, the fifth node 115, the group of devices 130, and/or another node, through a receiving port 1605. In some examples, the receiving port 1605 may be, for example, connected to one or more antennas in the sixth node 116. In other embodiments, the sixth node 116 may receive information from another structure in the communications system 100 through the receiving port 1605. Since the receiving port 1605 may be in communication with the processor 1603, the receiving port 1605 may then send the received information to the processor 1603. The receiving port 1605 may also be configured to receive other information.

The processor 1603 in the sixth node 116 may be further configured to transmit or send information to e.g., the first node 111, the second node 112, the one or more third nodes 113, the fourth node 114, the fifth node 115, the group of devices 130, another node and/or another structure in the communications system 100, through a sending port 1606, which may be in communication with the processor 1603, and the memory 1604.

Those skilled in the art will also appreciate that the units 1601-1602 described above may refer to a combination of analog and digital circuits, and/or one or more processors configured with software and/or firmware, e.g., stored in memory, that, when executed by the one or more processors such as the processor 1603, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1601-1602 described above may be the processor 1603 of the sixth node 116, or an application running on such processor.

Thus, the methods according to the embodiments described herein for the sixth node 116 may be respectively implemented by means of a computer program 1607 product, comprising instructions, i.e., software code portions, which, when executed on at least one processor 1603, cause the at least one processor 1603 to carry out the actions described herein, as performed by the sixth node 116. The computer program 1607 product may be stored on a computer-readable storage medium 1608. The computer-readable storage medium 1608, having stored thereon the computer program 1607, may comprise instructions which, when executed on at least one processor 1603, cause the at least one processor 1603 to carry out the actions described herein, as performed by the sixth node 116. In some embodiments, the computer-readable storage medium 1608 may be a non-transitory computer-readable storage medium, such as a CD ROM disc, a memory stick, or stored in the cloud space. In other embodiments, the computer program 1607 product may be stored on a carrier containing the computer program, wherein the carrier is one of an electronic signal, optical signal, radio signal, or the computer-readable storage medium 1608, as described above.

The sixth node 116 may comprise an interface unit to facilitate communications between the sixth node 116 and other nodes or devices, e.g., the first node 111, the second node 112, the one or more third nodes 113, the fourth node 114, the fifth node 115, the group of devices 130, another node and/or another structure in the communications system 100. In some particular examples, the interface may, for example, include a transceiver configured to transmit and receive radio signals over an air interface in accordance with a suitable standard.

In other embodiments, the sixth node 116 may comprise the following arrangement depicted in FIG. 16b. The sixth node 116 may comprise a processing circuitry 1603, e.g., one or more processors such as the processor 1603, in the sixth node 116 and the memory 1604. The sixth node 116 may also comprise a radio circuitry 1609, which may comprise e.g., the receiving port 1605 and the sending port 1606. The processing circuitry 1603 may be configured to, or operable to, perform the method actions according to FIG. 8 and/or FIGS. 10-12, in a similar manner as that described in relation to FIG. 16a. The radio circuitry 1609 may be configured to set up and maintain at least a wireless connection with the first node 111, the second node 112, the one or more third nodes 113, the fourth node 114, the fifth node 115, the group of devices 130, another node and/or another structure in the communications system 100.

Hence, embodiments herein also relate to the sixth node 116 operative for handling information configured to pertain to a group of devices 130, the sixth node 116 being operative to operate in the communications system 100. The sixth node 116 may comprise the processing circuitry 1603 and the memory 1604, said memory 1604 containing instructions executable by said processing circuitry 1603, whereby the sixth node 116 is further operative to perform the actions described herein in relation to the sixth node 116, e.g., in FIG. 8 and/or FIGS. 10-12.

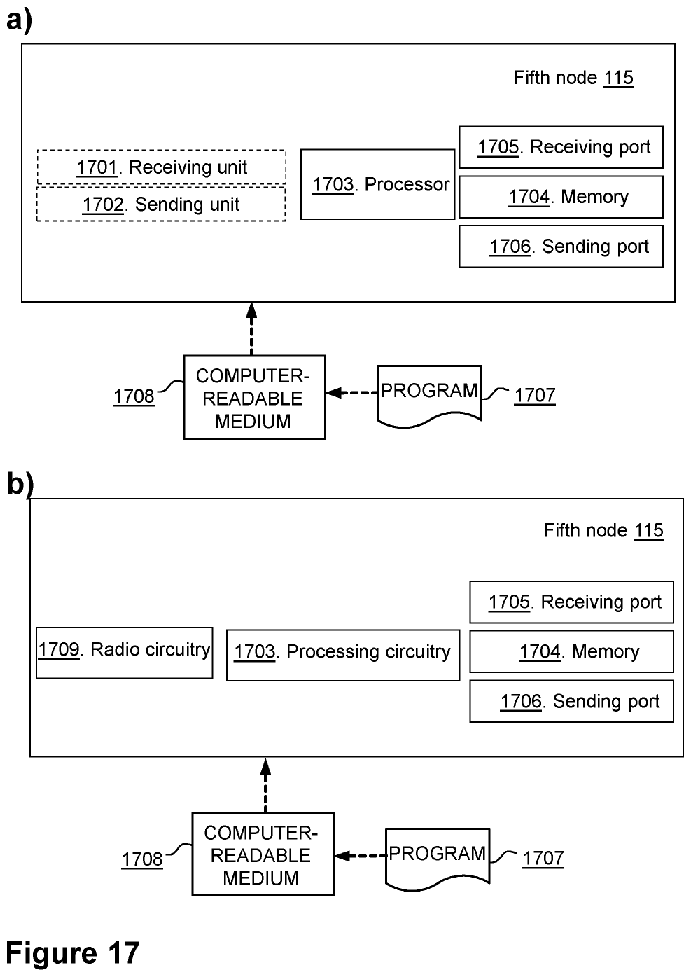

FIG. 17 depicts two different examples in panels a) and b), respectively, of the arrangement that the fifth node 115, may comprise to perform the method actions described above in relation to FIG. 9 and/or FIGS. 10-12. In some embodiments, the fifth node 115 may comprise the following arrangement depicted in FIG. 17a. The fifth node 115 may be understood to be for handling information configured to pertain to a group of devices 130. The fifth node 115 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 17, optional boxes are indicated by dashed lines. The detailed description of some of the following corresponds to the same references provided above, in relation to the actions described for the fifth node 115 and will thus not be repeated here. For example, in some embodiments, the fifth node 115 may be configured to be the UDR, and the first node 111 may be configured to be the UDM.

The fifth node 115 is configured to, e.g., by means of a receiving unit 1701 within the fifth node 115 configured to, receive the second prior request from the first node 111 configured to operate in the communications system 100. The second prior request is configured to request the first prior information. The first prior information is configured to indicate whether or not the group of devices 130 are restricted to operate in the limited group of areas.

The fifth node 115 is also configured to, e.g., by means of a sending unit 1702 within the fifth node 115 configured to, send, in response to the received second prior request, the first prior response to the first node 111. The first prior response is configured to comprise the requested first prior information.

In some embodiments, at least one of the following may apply: a) the second prior request may be configured to be the Nudr_DataRepository_Query request, b) the first prior request may be configured to comprise the third flag configured to explicitly indicate that the first prior information requested is to indicate whether or not the group of devices 130 may be restricted to operate in the limited group of areas, c) the second prior request may be configured to comprise the third flag, d) the third flag may be configured to be the narrowed mobility data flag in the Nudm_SubscriberDataManagement_Get request, e) each of the one or more areas may be configured to be identified by a TAI, f) the first prior response may be configured to be the Nudr_DataRepository_Query response, g) the communications system 100 may be configured to be the 5G system, h) the first node 111 may be configured to be the UDM node, i) the fifth node 115 may be configured to be the UDR, j) any of the first prior response and the second prior response may be configured to comprise the fourth flag configured to indicate whether or not the group of devices 130 may be restricted to operate in the limited group of areas, k) the fourth flag in the first prior response may be configured to be the narrowed-mobility indication in the Nudr_DataRepository_Query response, l) the fourth flag in the second prior response may be configured to be the narrowed-mobility indication in the Nudm_SubscriberDataManagement_Get response, and m) the first prior response may be further configured to comprise the GeoArea.

The embodiments herein may be implemented through one or more processors, such as a processor 1703 in the fifth node 115 depicted in FIG. 17, together with computer program code for performing the functions and actions of the embodiments herein. The program code mentioned above may also be provided as a computer program product, for instance in the form of a data carrier carrying computer program code for performing the embodiments herein when being loaded into the fifth node 115. One such carrier may be in the form of a CD ROM disc. It is however feasible with other data carriers such as a memory stick. The computer program code may furthermore be provided as pure program code on a server and downloaded to the fifth node 115.

The fifth node 115 may further comprise a memory 1704 comprising one or more memory units. The memory 1704 is arranged to be used to store obtained information, store data, configurations, schedulings, and applications etc. to perform the methods herein when being executed in the fifth node 115.

In some embodiments, the fifth node 115 may receive information from, e.g., the first node 111, the second node 112, the one or more third nodes 113, the fourth node 114, the sixth node 116, the group of devices 130, and/or another node, through a receiving port 1705. In some examples, the receiving port 1705 may be, for example, connected to one or more antennas in the fifth node 115. In other embodiments, the fifth node 115 may receive information from another structure in the communications system 100 through the receiving port 1705. Since the receiving port 1705 may be in communication with the processor 1703, the receiving port 1705 may then send the received information to the processor 1703. The receiving port 1705 may also be configured to receive other information.

The processor 1703 in the fifth node 115 may be further configured to transmit or send information to e.g., the first node 111, the second node 112, the one or more third nodes 113, the fourth node 114, the sixth node 116, the group of devices 130, another node and/or another structure in the communications system 100, through a sending port 1706, which may be in communication with the processor 1703, and the memory 1704.

Those skilled in the art will also appreciate that any of the units 1701-1702 described above may refer to a combination of analog and digital circuits, and/or one or more processors configured with software and/or firmware, e.g., stored in memory, that, when executed by the one or more processors such as the processor 1703, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1701-1702 described above may be the processor 1703 of the fifth node 115, or an application running on such processor.

Thus, the methods according to the embodiments described herein for the fifth node 115 may be respectively implemented by means of a computer program 1707 product, comprising instructions, i.e., software code portions, which, when executed on at least one processor 1703, cause the at least one processor 1703 to carry out the actions described herein, as performed by the fifth node 115. The computer program 1707 product may be stored on a computer-readable storage medium 1708. The computer-readable storage medium 1708, having stored thereon the computer program 1707, may comprise instructions which, when executed on at least one processor 1703, cause the at least one processor 1703 to carry out the actions described herein, as performed by the fifth node 115. In some embodiments, the computer-readable storage medium 1708 may be a non-transitory computer-readable storage medium, such as a CD ROM disc, a memory stick, or stored in the cloud space. In other embodiments, the computer program 1707 product may be stored on a carrier containing the computer program, wherein the carrier is one of an electronic signal, optical signal, radio signal, or the computer-readable storage medium 1708, as described above.

The fifth node 115 may comprise an interface unit to facilitate communications between the fifth node 115 and other nodes or devices, e.g., the first node 111, the second node 112, the one or more third nodes 113, the fourth node 114, the sixth node 116, the group of devices 130, another node and/or another structure in the communications system 100. In some particular examples, the interface may, for example, include a transceiver configured to transmit and receive radio signals over an air interface in accordance with a suitable standard.

In other embodiments, the fifth node 115 may comprise the following arrangement depicted in FIG. 17b. The fifth node 115 may comprise a processing circuitry 1703, e.g., one or more processors such as the processor 1703 in the fifth node 115 and the memory 1704. The fifth node 115 may also comprise a radio circuitry 1709, which may comprise e.g., the receiving port 1705 and the sending port 1706. The processing circuitry 1703 may be configured to, or operable to, perform the method actions according to FIG. 9 and/or FIGS. 10-12, in a similar manner as that described in relation to FIG. 17a. The radio circuitry 1709 may be configured to set up and maintain at least a wireless connection with the first node 111, the second node 112, the one or more third nodes 113, the fourth node 114, the sixth node 116, the group of devices 130, another node and/or another structure in the communications system 100.

Hence, embodiments herein also relate to the fifth node 115 operative for handling information configured to pertain to a group of devices 130, the fifth node 115 being operative to operate in the communications system 100. The fifth node 115 may comprise the processing circuitry 1703 and the memory 1704, said memory 1704 containing instructions executable by said processing circuitry 1703, whereby the fifth node 115 is further operative to perform the actions described herein in relation to the fifth node 115, e.g., in FIG. 9 and/or FIGS. 10-12.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or”term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. 3GPP TS 29.522 version 17.3.0: Network Exposure Function Northbound APIs.

1. A computer-implemented method, performed by a first node, the method being for handling information pertaining to a group of devices, the first node operating in a communications system, the method comprising:
receiving a first request from a second node operating in the communications system, the first request being to receive first information pertaining to an event for the group of devices, the request comprising a first indication, the first indication indicating that the group of devices is restricted to operate in one or more areas covered by the communications system, the one or more areas being indicated by the second node;
sending, responsive to the received first request, a second request to a fourth node operating in the communications system, the second request requesting to receive second information regarding which one or more third nodes serve at least one of the indicated one or more areas;
receiving, responsive to the sent second request, a first response comprising the requested second information; and
sending, responsive to the obtained second information, a respective additional request to the one or more third nodes, the respective additional request requesting to receive the first information for the group of devices.

2. The method according to claim 1, the method further comprising:
receiving a first prior request from the second node, the first prior request being to request first prior information indicating whether or not the group of devices is restricted to operate in a limited group of areas;
sending, responsive to the received first prior request, a second prior request to a fifth node operating in the communications system, the second prior request requesting the first prior information;
receiving, in response to the sent second prior request, from the fifth node, a first prior response comprising the requested first prior information;
sending, responsive to the received first prior response, a second prior response to the second node, the second prior response comprising the first prior information, and wherein the received first request is based on the sent second prior response.

3. (canceled)

4. The method according to claim 1, wherein at least one of:
a. the first indication is a first flag in a subscription request;
b. each of the one or more areas is identified by a Tracking Area Information, TAI;
c. the one or more areas are identified by a list of TAIs;
d. the communications system is a Fifth Generation, 5G, system;
e. the first node is a Unified Data Management, UDM, node;
f. the second node is a Network Exposure Function, NEF, node;
g. the fourth node is a Network Repository Function, NRF, node;
h. each of the one or more third nodes is an Access and Mobility Management Function, AMF, node;
i. the first request is a Nudm_EventExposure_Subscribe message;
j. the second request is an Nnrf_NFDiscovery_NFDiscover request;
k. the second request comprises a second flag explicitly indicating that the second information is to be regarding which one or more third nodes serve at least one of the indicated one or more areas;
l. the second flag is an Nnrf_NFDiscover flag;
m. the first response is an Nnrf_NFDiscovery_NF Discover response; and
n. each respective additional request is a Namf_EventExposure_Subscribe request.

5. The method according to claim 4, wherein the first flag is a narrowed-mobility flag in a Nnef_EventExposure_Subscribe request.

6. The method according to claim 2, wherein at least one of:
a. the fifth node is a Unified Data Repository, UDR;
b. the first prior request is a Nudm_SubscriberDataManagement_Get request;
c. the first prior request comprises a third flag explicitly indicating that the first prior information requested is to indicate whether or not the group of devices is restricted to operate in a limited group of areas;
d. the third flag is a narrowed mobility data flag in the Nudm_SubscriberDataManagement_Get request;
e. the second prior request is a Nudr_DataRepository_Query request;
f. the first prior response is a Nudr_DataRepository_Query response;
g. the second prior request comprises the third flag;
h. the second prior request further comprises a GeoArea;
i. the second prior response is a Nudm_SubscriberDataManagement_Get response;
j. the second prior response further comprises the GeoAreav;
k. any of the first prior response and the second prior response comprises a fourth flag indicating whether or not the group of devices is restricted to operate in the limited group of areas;
l. the fourth flag in the first prior response is a narrowed-mobility indication in the Nudr_DataRepository_Query response;
m. the fourth flag in the second prior response is a narrowed-mobility indication in the Nudm_SubscriberDataManagement_Get response; and
n. the first prior response further comprises the GeoArea.

7. A computer-implemented method, performed by a second node the method being for handling information pertaining to a group of devices, the second node operating in a communications system, the method comprising:
receiving a first previous request from a sixth node operating with the communications synode; and, the first previous request being to receive first information pertaining to an event for the group of devices, the first previous request comprising a first indication, the first indication indicating that the group of devices is restricted to operate in one or more areas covered by the communications system, the one or more areas being indicated by the sixth node; and
sending, responsive to the received first previous request, a first request to a first node operating in the communications system the first request being to receive the first information, the request comprising a first indication, the first indication indicating that the group of devices is restricted to operate in one or more areas covered by the communications system, the one or more areas being obtained by the second node, and wherein by sending the first request, the second node initiates a provision of the first information to the sixth node.

8. The method according to claim 7, the method further comprising:
sending, responsive to the received first previous request, a first prior request to the first node, the first prior request being to request first prior information indicating whether or not the group of devices is restricted to operate in a limited group of areas; and
receiving, responsive to the sent first prior request, a second prior response from the first node, the second prior response comprising the first prior information, and wherein the sent first request is based on the received second prior response.

9. The method according to claim 7, wherein at least one of:
a. the first indication is a first flag in a subscription request;
b. each of the one or more areas is identified by a Tracking Area Information, TAI;
c. the one or more areas are identified by a list of TAIs;
d. the communications system is a Fifth Generation, 5G, system;
e. the first node is a Unified Data Management, UDM, node;
f. the second node is a Network Exposure Function, NEF, node;
g. the sixth node is an Application Function, AF, node; and
h. the first previous request is a Nnef_EventExposure_Subscribe request.

10. The method according to claim 9, wherein the first flag is a narrowed-mobility flag in a Nudm_EventExposure_Subscribe request.

11. The method according to claim 7, wherein at least one of:
a. the first prior request is a Nudm_SubscriberDataManagement_Get request;
b. the first prior request comprises a third flag explicitly indicating that the first prior information requested is to indicate whether or not the group of devices is restricted to operate in a limited group of areas;
c. the third flag is a narrowed mobility data flag in the Nudm_SubscriberDataManagement_Get request;
d. the second prior response is a Nudm_SubscriberDataManagement_Get responsev
e. the second prior response comprises a fourth flag indicating whether or not the group of devices is restricted to operate in the limited group of areas; and
f. the second prior response further comprises a GeoArea.

12.-18. (canceled)

19. A first node, for handling information configured to pertain to a group of devices, the first node being further configured to operate in a communications system, the first node being further configured to:
receive a first request from a second node configured to operate in the communications system, the first request being configured to be to receive first information configured to pertain to an event for the group of devices, the request being configured to comprise a first indication, the first indication being configured to indicate that the group of devices is restricted to operate in one or more areas configured to be covered by the communications system, the one or more areas being configured to be indicated by the second node;
send, responsive to the received first request, a second request to a fourth node configured to operate in the communications system, the second request being configured to request to receive second information configured to be regarding which one or more third nodes are configured to serve at least one of the indicated one or more areas;
receive, responsive to the sent second request, a first response configured to comprise the requested second information; and
send, responsive to the obtained second information, a respective additional request to the one or more third nodes, the respective additional request being configured to request to receive the first information for the group of devices.

20. The first node according to claim 19, the first node being further configured to:
receive a first prior request from the second node, the first prior request being configured to request first prior information configured to indicate whether or not the group of devices is restricted to operate in a limited group of areas;
send, responsive to the received first prior request, a second prior request to a fifth node configured to operate in the communications system, the second prior request being configured to request the first prior information;
receive, in response to the sent second prior request, from the fifth node, a first prior response configured to comprise the requested first prior information;
send, responsive to the received first prior response, a second prior response to the second node, the second prior response being configured to comprise the first prior information, and wherein the received first request is configured to be based on the sent second prior response.

21. (canceled)

22. The first node according to claim 19, wherein at least one of:
a. the first indication is configured to be a first flag in a subscription request;
b. each of the one or more areas is configured to be identified by a Tracking Area Information, TAI;
c. the one or more areas are configured to be identified by a list of TAIs;
d. the communications system is configured to be a Fifth Generation, 5G, system;
e. the first node is configured to be a Unified Data Management, UDM, node;
f. the second node is configured to be a Network Exposure Function, NEF, node;
g. the fourth node is configured to be a Network Repository Function, NRF, node;
h. each of the one or more third nodes is configured to be an Access and Mobility Management Function, AMF, node;
i. the first request is configured to be a Nudm_EventExposure_Subscribe message;
j. the second request is configured to be an Nnrf_NFDiscovery_NFDiscover request;
k. the second request is configured to comprise a second flag configured to explicitly indicate that the second information is to be regarding which one or more third nodes serve at least one of the indicated one or more areas;
l. the second flag is configured to be an Nnrf_NFDiscover flag;
m. the first response is configured to be an Nnrf_NFDiscovery_NF Discover response; and
n. each respective additional request is configured to be a Namf_EventExposure_Subscribe request.

23. The first node according to claim 22, wherein the first flag is configured to be a narrowed-mobility flag in a Nnef_EventExposure_Subscribe request.

24. The first node according to claim 20, wherein at least one of:
a. the fifth node is configured to be a Unified Data Repository, UDR;
b. the first prior request is configured to be a Nudm_SubscriberDataManagement_Get request;
the first prior request is configured to comprise a third flag configured to explicitly indicate that the first prior information requested is to indicate whether or not the group of devices is restricted to operate in a limited group of areas;
d. the third flag is configured to be a narrowed mobility data flag in the Nudm_SubscriberDataManagement_Get request;
e. the second prior request is configured to be a Nudr_DataRepository_Query request;
f. the first prior response is configured to be a Nudr_DataRepository_Query response;
g. the second prior request is configured to comprise the third flag;
h. the second prior request is configured to further comprise a GeoArea;
i. the second prior response is configured to be a Nudm_SubscriberDataManagement_Get response;
j. the second prior response is further configured to comprise the GeoArea;
k. any of the first prior response and the second prior response is configured to comprise a fourth flag configured to indicate whether or not the group of devices is restricted to operate in the limited group of areas;
l. the fourth flag in the first prior response is configured to be a narrowed-mobility indication in the Nudr_DataRepository_Query response;
m. the fourth flag in the second prior response is configured to be a narrowed-mobility indication in the Nudm_SubscriberDataManagement_Get response; and
n. the first prior response is further configured to comprise the GeoArea.

25. A second node, for handling information configured to pertain to a group of devices, the second node being configured to operate in a communications system, the second node being further configured to:
receive a first previous request from a sixth node configured to operate with the communications system, the first previous request being configured to be to receive first information configured to pertain to an event for the group of devices, the first previous request being configured to comprise a first indication, the first indication being configured to indicate that the group of devices is restricted to operate in one or more areas configured to be covered by the communications system, the one or more areas being configured to be indicated by the sixth node; and
send, responsive to the received first previous request, a first request to a first node configured to operate in the communications system, the first request being configured to be to receive the first information, the request being configured to comprise a first indication, the first indication being configured to indicate that the group of devices is restricted to operate in one or more areas configured to be covered by the communications system, the one or more areas being configured to be obtained by the second node, and by sending the first request, the second node being configured to initiate a provision of the first information to the sixth node.

26. The second node according to claim 25, the second node being further configured to:
send, responsive to the received first previous request, a first prior request to the first node, the first prior request being configured to be to request first prior information configured to indicate whether or not the group of devices is configured to be restricted to operate in a limited group of areas; and
receive, responsive to the sent first prior request, a second prior response from the first node, the second prior response being configured to comprise the first prior information, and wherein the sent first request is configured to be based on the received second prior response.

27. The second node according to claim 25, wherein at least one of:
a. the first indication is configured to be a first flag in a subscription request;
b. each of the one or more areas is configured to be identified by a Tracking Area Information, TAI;
c. the one or more areas are configured to be identified by a list of TAIs;
d. the communications system is configured to be a Fifth Generation, 5G, system;
e. the first node is configured to be a Unified Data Management, UDM, node,
f. the second node is configured to be a Network Exposure Function, NEF, node;
g. the sixth node is configured to be an Application Function, AF, node; and
h. the first previous request is configured to be a Nnef_EventExposure_Subscribe request.

28. The second node according to claim 27, wherein the first flag is configured to be a narrowed-mobility flag in a Nudm_EventExposure_Subscribe request.

29. The second node according to claim 25, wherein at least one of:
a. the first prior request is configured to be a Nudm_SubscriberDataManagement_Get request;
b. the first prior request is configured to comprise a third flag configured to explicitly indicate that the first prior information requested is configured to be to indicate whether or not the group of devices is restricted to operate in a limited group of areas;
c. the third flag is configured to be a narrowed mobility data flag in the Nudm_SubscriberDataManagement_Get request;
d. the second prior response is configured to be a Nudm_SubscriberDataManagement_Get responsev
e. the second prior response is configured to comprise a fourth flag configured to indicate whether or not the group of devices is restricted to operate in the limited group of areas; and
f. the second prior response is further configured to comprise a GeoArea.

30.-36. (canceled)
